(19) United States
(12) Patent Application Publication
(10) Pub. No.: US 2026/0093393 A1
(43) Pub. Date: Apr. 2, 2026

(54) METHOD OF GENERATING DRAWING BASED ON TOUCH INPUT AND ELECTRONIC DEVICE FOR PERFORMING THE SAME

(71) Applicant: SAMSUNG ELECTRONICS CO., LTD., Suwon-si (KR)

(72) Inventors: Grzegorz Pawel GRZESIAK, Warszawa (PL); Michal SZCZECINSKI, Warszawa (PL)

(73) Assignee: SAMSUNG ELECTRONICS CO., LTD., Suwon-si (KR)

(21) Appl. No.: 19/341,671

(22) Filed: Sep. 26, 2025

Related U.S. Application Data
(63) Continuation of application No. PCT/KR2025/014222, filed on Sep. 12, 2025.

(30) Foreign Application Priority Data
Sep. 27, 2024 (KR) 10-2024-0132011

(51) Int. Cl. G06F 3/04883; G06F 3/041

(52) U.S. Cl. CPC G06F 3/04883; G06F 3/0416

(57) ABSTRACT

A method, performed by an electronic device, of predicting a drawing point, includes: detecting a first touch input; estimating, as a first time, a time from the detection of the first touch input until a screen is refreshed; estimating, as a second time, a time to render a first drawing including a first drawing point corresponding to the first touch input; selecting a first prediction model for predicting the first drawing point, based on the first time and the second time; predicting the first drawing point from the first touch input by using the selected first prediction model; and displaying, on the screen, the first drawing including the first drawing point.

### CROSS-REFERENCE TO RELATED APPLICATION(S)

This application is a continuation of International Application No. PCT/KR2025/014222, filed on Sep. 12, 2025, in the Korean Intellectual Property Receiving Office, which is based on and claims priority to Korean Patent Application No. 10-2024-0132011, filed on Sep. 27, 2024, in the Korean Intellectual Property Office, the disclosures of which are incorporated by reference herein in their entireties.

### BACKGROUND

### 1. Field

The disclosure relates to an electronic device, a method, and a system for generating a drawing based on a touch input by using a prediction model.

### 2. Description of Related Art

Prediction artificial intelligence (AI) is an AI technology used to predict future events or results based on past data. Various algorithms and machine learning techniques are used to analyze data patterns and predict results that have not yet occurred. For example, a prediction model may be used to generate or supplement lines or shapes by predicting results highly likely to occur next, based on a user input or data.

A screen refresh time may usually be defined by frames per second (FPS) or frequency (Hz). For example, a monitor with a refresh rate of 60 Hz may have a screen refresh time of 16.67 ms. Display devices, such as monitors, televisions (TVs), projectors, or the like constantly update images displayed on screens, and the screen refresh time may indicate how often this update occurs.

A whiteboard is a type of electronic device with a display and a touchscreen and may be a device in which digital technology is combined with a traditional physical whiteboard. A whiteboard may recognize an electronic input, store written contents in a digital manner, or provide a collaborative function that allows sharing with others in real time. When a screen is touched, input data moves to a processor, and the processor interprets the input data and requests a graphics processing unit (GPU) to draw specific elements on a virtual canvas displayed on the screen.

### SUMMARY

Aspects will be set forth in part in the description which follows and, in part, will be apparent from the description, or may be learned by practice of the presented embodiments.

According to an aspect of the disclosure, a method, performed by an electronic device, of predicting a drawing point, may include: detecting a first touch input; estimating, as a first time, a time from the detection of the first touch input until a screen is refreshed; estimating, as a second time, a time to render a first drawing including a first drawing point corresponding to the first touch input; selecting a first prediction model for predicting the first drawing point, based on the first time and the second time; predicting the first drawing point from the first touch input by using the selected first prediction model; and displaying, on the screen, the first drawing including the first drawing point.

The method may further include: detecting a second touch input; estimating, as a third time, a time from the detection of the second touch input until the screen is refreshed; estimating, as a fourth time, a time to render a second drawing including a second drawing point corresponding to the second touch input; determining whether to perform a prediction on the second touch input, based on the third time and the fourth time; based on determining to perform the prediction on the second touch input, selecting a second prediction model for predicting the second drawing point, based on the third time and the fourth time; predicting the second drawing point from the second touch input by using the selected second prediction model; and displaying, on the screen, the second drawing including the second drawing point.

The method may further include, based on determining not to perform the prediction on the second touch input, performing the prediction on the second touch input after the screen is refreshed.

The first prediction model may include a neural network model trained to predict the first drawing point from the first touch input by using past touch inputs as training data, and the second prediction model may include a neural network model trained to predict the second drawing point from the second touch input by using the past touch inputs as training data.

The method may further include: estimating, as a fifth time, a time for which a screen refresh is delayed; predicting a third drawing point corresponding to the first touch input, based on the first time, the second time and the fifth time; and displaying, on the screen, a third drawing including the first drawing point and the third drawing point.

The method may further include: identifying, as a sixth time, a time for which a screen refresh is delayed; predicting a fourth drawing point from the first touch input, based on the second time and the sixth time; and displaying, on the screen, a fourth drawing including the first drawing point and the fourth drawing point.

The displaying, on the screen, the first drawing including the first drawing point may include: selecting, among at least one prediction result, the first drawing point based on the first time, the second time, an accuracy, and an error probability; and displaying, on the screen, the first drawing including the selected first drawing point.

The displaying, on the screen, the first drawing including the first drawing point may include adjusting a screen refresh time to synchronize a time at which the first drawing is displayed on the screen with a time at which the screen is refreshed.

The method may further include: analyzing a pattern of a time interval between touch inputs; estimating a seventh time at which the second touch input is to be detected, based on the analyzed pattern of the time interval; and determining whether to perform a prediction on the first touch input, based on the first time, the second time, and the seventh time.

The method may further include, based on determining not to perform the prediction on the first touch input, stop performing the prediction on the first touch input until the second touch input is detected.

According to an aspect of the disclosure, an electronic device for predicting a drawing point may include: an input interface; an output interface; memory storing at least one instruction; and at least one processor configured to execute the at least one instruction stored in the memory to cause the electronic device to: detect a first touch input, estimate, as a first time, a time from the detection of the first touch input until a screen is refreshed, estimate, as a second time, a time to render a first drawing including a first drawing point corresponding to the first touch input, select a first prediction model for predicting the first drawing point, based on the first time and the second time, predict the first drawing point from the first touch input by using the selected first prediction model, and display, on the screen, the first drawing including the first drawing point.

The at least one processor may be further configured to execute the at least one instruction to cause the electronic device to: detect a second touch input, estimate, as a third time, a time from the detection of the second touch input until the screen is refreshed, estimate, as a fourth time, a time to render a second drawing including a second drawing point corresponding to the second touch input, determine whether to perform a prediction on the second touch input, based on the third time and the fourth time, based on determining to perform the prediction on the second touch input, select a second prediction model for predicting the second drawing point, based on the third time and the fourth time, predict the second drawing point from the second touch input by using the selected second prediction model, and display, on the screen, the second drawing including the second drawing point.

The at least one processor may be further configured to execute the at least one instruction to cause the electronic device to, based on determining not to perform the prediction on the second touch input, perform the prediction on the second touch input after the screen is refreshed.

The first prediction model may include a neural network model trained to predict the first drawing point from the first touch input by using past touch inputs as training data, and the second prediction model may include a neural network model trained to predict the second drawing point from the second touch input by using the past touch inputs as training data.

The at least one processor may be further configured to execute the at least one instruction to cause the electronic device to: estimate, as a fifth time, a time for which a screen refresh is delayed, predict a third drawing point from the first touch input, based on the first time, the second time and the fifth time, and display, on the screen, the third drawing include the first drawing point and the third drawing point.

The at least one processor may be further configured to execute the at least one instruction to cause the electronic device to: identify, as a sixth time, a time for which a screen refresh is delayed, predict a fourth drawing point from the first touch input, based on the second time and the sixth time, and display, on the screen, a fourth drawing including the first drawing point and the fourth drawing point.

The at least one processor may be further configured to execute the at least one instruction to cause the electronic device to: select the first drawing point, among at least one prediction result, based on the first time, the second time, an accuracy, and an error probability, and display, on the screen, the first drawing including the selected first drawing point.

The at least one processor may be further configured to execute the at least one instruction to cause the electronic device to: adjust a screen refresh time to synchronize a time at which the first drawing is displayed on the screen with a time at which the screen is refreshed.

The at least one processor may be further configured to execute the at least one instruction to cause the electronic device to: analyze a pattern of a time interval between touch inputs, estimate a seventh time at which the second touch input is to be detected, based on the analyzed pattern of the time interval, and determine whether to perform a prediction on the first touch input, based on the first time, the second time, and the seventh time.

According to an aspect of the disclosure, a computer-readable recording medium having recorded thereon a program for causing a computer to perform a method, the method may include: detecting a first touch input; estimating, as a first time, a time from the detection of the first touch input until a screen is refreshed; estimating, as a second time, a time to render a first drawing including a first drawing point corresponding to the first touch input; selecting a first prediction model for predicting the first drawing point, based on the first time and the second time; predicting the first drawing point from the first touch input by using the selected first prediction model; and displaying, on the screen, the first drawing including the first drawing point.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating an example of performing drawing on an electronic device by using a prediction model, according to an embodiment of the disclosure;

FIG. 2 is a diagram illustrating a time delay that occurs in processing a touch input, according to an embodiment of the disclosure;

FIG. 3 is a flowchart illustrating a method of processing one touch input, according to an embodiment of the disclosure;

FIG. 4 is a timeline diagram illustrating a process of processing one touch input, according to an embodiment of the disclosure;

FIG. 5 is a flowchart illustrating a method of processing two or more touch inputs, according to an embodiment of the disclosure;

FIG. 6 is a timeline diagram illustrating a process of processing two or more touch inputs, according to an embodiment of the disclosure;

FIG. 7 is a flowchart illustrating a method of processing a touch input based on a screen refresh delay, according to an embodiment of the disclosure;

FIG. 8 is a timeline diagram illustrating a process of processing a touch input based on a screen refresh delay, according to an embodiment of the disclosure;

FIG. 9 is a flowchart illustrating a method of processing a touch input when screen refresh is delayed, according to an embodiment of the disclosure;

FIG. 10 is a flowchart illustrating an operation of predicting a drawing point, according to an embodiment of the disclosure; and

FIG. 11 is a block diagram illustrating a configuration of an electronic device, according to an embodiment of the disclosure.

### DETAILED DESCRIPTION

The terms as used herein are briefly described and the disclosure is described in detail. Throughout the disclosure, the expression “at least one of a, b or c” indicates only a, only b, only c, both a and b, both a and c, both b and c, all of a, b, and c, or variations thereof.

As for the terms as used in the disclosure, common terms that are currently widely used are selected as much as possible while taking into account the functions in the disclosure. However, the terms may vary depending on the intention of those of ordinary skill in the art, precedents, the emergence of new technology, and the like. Also, in a specific case, there are also terms arbitrarily selected by the applicant. In this case, the meaning of the terms will be described in detail in the description of the disclosure. Therefore, the terms as used herein should be defined based on the meaning of the terms and the description throughout the disclosure rather than simply the names of the terms.

The singular forms as used herein are intended to include the plural forms as well unless the context clearly indicates otherwise. Unless defined otherwise, all terms including technical or scientific terms as used herein have the same meaning as commonly understood by those of ordinary skill in the art. It will be understood that although the terms “first,” “second,” etc. may be used to describe various elements, these elements should not be limited by these terms. These terms are only used to distinguish one element from another.

Throughout the disclosure, the expression “a portion includes a certain element” means that a portion further includes other elements rather than excludes other elements unless otherwise stated. Similarly, the expressions “a portion has a certain element” and “a portion comprises a certain element” that a portion further includes other elements rather than excludes other elements unless otherwise stated. Also, the terms such as “unit” and “module” described in the specification mean units that process at least one function or operation, and may be implemented as hardware, software, or a combination of hardware and software.

Hereinafter, an embodiment of the disclosure will be described in detail with reference to the accompanying drawings, so that those of ordinary skill in the art may easily carry out the disclosure. However, the disclosure may be implemented in various different forms and is not limited to the embodiment of the disclosure described herein. In order to clearly explain the disclosure, parts irrelevant to the description are omitted in the drawings, and similar reference numerals are assigned to similar parts throughout the specification.

Hereinafter, the disclosure is described with reference to the accompanying drawings.

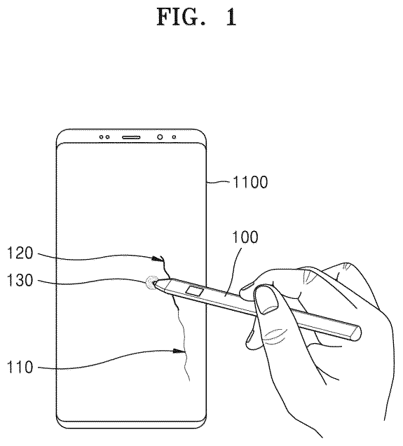

FIG. 1 is a diagram illustrating an example of performing drawing on an electronic device 1100 by using a prediction model, according to an embodiment of the disclosure.

The electronic device 1100 may include an input interface and an output interface. The input interface and the output interface may be separate components, or may be integrated to operate as a single component. For example, referring to FIG. 1, the electronic device 1100 may include a display and a touchscreen. The display may be referred to as the output interface and the touchscreen may be referred to as the input interface. In an embodiment of the disclosure, when a touch input is detected on the touchscreen of the electronic device 1100, the electronic device 1100 may display, on the display, a dot or a line corresponding to the touch input.

In an embodiment of the disclosure, the touch input may refer to an input in which a user directly presses and manipulates the screen of an electronic device 1100 by using a finger of the user or an input device 100 such as a stylus pen. However, the disclosure is not limited thereto. For example, in some embodiments, the touch input may refer to a detection of a user's finger or input device 100 on another surface or device, without requiring direct physical contact with the electronic device 1100. For the sake of explanation, the embodiment in the user directly presses and manipulates the screen of the electronic device is primarily referred to, but this is merely an example, and the disclosure is not limited thereto.

In an embodiment of the disclosure, when the user moves on the touchscreen of the electronic device 1100 by using the input device 100 or the finger of the user, the electronic device 1100 may display a dot or a line on the display according to the movement.

In an embodiment of the disclosure, the electronic device 1100 may require time to process data for the touch input. In an embodiment of the disclosure, when a line is drawn by using the input device 100, the current position of the input device 100 may be different from the end point of the line displayed on the display due to data processing of the electronic device 1100 for the touch input.

In an embodiment of the disclosure, the touchscreen of the electronic device 1100 may require time to accumulate data depending on the resistance and capacitance thereof. The touchscreen may require time to transmit data to the processor. For example, the processor may include a central processing unit (CPU). The processor may require time to process the data and transmit the processed data to a graphics processing unit (GPU).

In an embodiment of the disclosure, the GPU may require time to process the data. After the GPU processes the data, the GPU may display content in units of frames. After the GPU processes the data, the GPU may display content at each screen refresh time. For example, when the refresh rate is 60 Hz, the screen refresh time may be 16.67 ms.

In an embodiment of the disclosure, when a line is drawn on the touchscreen of the electronic device 1100, the electronic device 1100 may experience a delay due to processing time of the touchscreen, the CPU, and the GPU. Assuming that the total processing time of the touchscreen, the CPU, and the GPU is 16 ms, a delay of 16 ms may occur between the line displayed on the display and the actual position of the finger of the user (or the input device 100).

In an embodiment of the disclosure, assuming that the input device 100 (or the finger of the user) moves from left to right by 1 cm every 16 ms, the operating method of the electronic device 1100 is as follows. The electronic device 1100 detects the touch input of the input device 100 (or the finger of the user) at a position of 0 cm. The touchscreen of the electronic device 1100 begins processing the touch input, and the input device 100 (or the finger of the user) moves to a position of 0.1 cm. The touchscreen processes the touch input and transmits the processed touch input to the CPU, and the input device 100 (or the finger of the user) moves to a position of 0.2 cm. The CPU copies memory to the GPU and requests the GPU to draw a dot or a line in response to the touch input. The input device 100 (or the finger of the user) is now at a position of 0.3 cm.

In an embodiment of the disclosure, when the screen refresh time is set to 60 Hz, the screen is refreshed every 16.67 ms. Accordingly, even after the data has been processed, the GPU may not display the data on the display until the screen refresh time arrives. The input device 100 (or the finger of the user) continues to move until the screen refresh time arrives. The GPU displays dots or lines on the display in response to the touch input according to the screen refresh time.

In an embodiment of the disclosure, a first line 110 may be a line that displays, on the display, a drawing generated based on past touch inputs. The first line 110 may be a line displayed on the display based on drawing data corresponding to the past touch inputs.

In an embodiment of the disclosure, the drawing data may refer to data generated when the input device 100 (or the finger of the user) draws dots or lines on the touchscreen of the electronic device 1100. The drawing data may include a history of drawings generated based on the past touch inputs. According to an embodiment of the disclosure, the prediction model may be trained based on the drawing data.

In an embodiment of the disclosure, a circular point 130 may refer to a point displayed to indicate the current position of the input device 100 (or the finger of the user). In an embodiment of the disclosure, the circular point 130 may not match the end point of the first line 110. In an embodiment of the disclosure, the circular point 130 may not match the end point of the first line 110 due to a time delay caused by data processing of the electronic device 1100.

In an embodiment of the disclosure, a second line 120 may be a line that displays, on the screen, a drawing generated based on drawing points predicted from drawing data by using the prediction model. In other words, when the prediction model, trained by using the drawing data including the history of drawings generated based on the past touch inputs, predicts the drawing points corresponding to the touch input of the input device 100 (or the finger of the user), a line that displays, on the screen, the drawing generated based on the predicted drawing points may be the second line 120. In an embodiment of the disclosure, due to the imperfection of the prediction model, the circular point 130 may not match the end point of the second line 120. The electronic device 1100 may use various prediction models to perform adjustment so that the predicted result matches the actual position of the input device 100 (or the finger of the user).

In an embodiment of the disclosure, the electronic device 1100 may provide a fast and smooth response by predicting a position of a next point (drawing point) to be drawn, based on a current movement pattern by using the prediction model. In an embodiment of the disclosure, the electronic device 1100 may draw smooth lines by predicting the flow of curves or straight lines in advance by using the prediction model. In an embodiment of the disclosure, because the electronic device 1100 predicts the drawing points by using the prediction model, the electronic device 1100 may provide a natural response without delay, may maintain line smoothness and consistency, and may correct unnecessary lines or provide improved results.

In an embodiment of the disclosure, the prediction model may refer to an artificial intelligence (AI) model used to predict future results based on past data. The prediction model may refer to a neural network model that analyzes data by using neural networks, learns patterns, and performs prediction. The prediction model may predict new data corresponding to input data, based on the features of the input data, by learning the patterns and structures of training data.

In an embodiment of the disclosure, the electronic device 1100 may be any type of device that processes the touch input. For example, the electronic device 1100 may be implemented as various types and forms of electronic devices including input and output interfaces. The electronic device 1100 may include devices capable of displaying, on the display, the touch input through the touchscreen, such as a smart TV, a smartphone, a tablet personal computer (PC), a laptop PC, a glasses-type display, a head mounted display (HMD), a projected display, or the like, but the disclosure is not limited thereto. For example, the electronic device 1100 may be implemented as various types and forms of electronic devices capable of wired/wireless connection with the display and the touchscreen. Furthermore, the electronic device 1100 may be a stationary electronic device disposed at a fixed position, a mobile electronic device having a portable form, or a digital broadcasting receiver capable of receiving digital broadcasting. However, the disclosure is not limited thereto.

In an embodiment of the disclosure, the input device 100 may be any type of device that interacts with the electronic device 1100 to generate a drawing on the display of the electronic device 1100. The input device 100 may be implemented as various types and forms of electronic device, and may be referred to as an electronic pen, a digital pen, a stylus, or a stylus pen. For example, the input device 100 may include devices that interact with the electronic device 1100, such as an S pen, a Wacom, an Apple pencil, a stylus, or a stylus pen.

In an embodiment of the disclosure, the means for generating a drawing on the display of the electronic device 1100 is not limited to an input device having a pen form, and may also include a case where a drawing is generated by using a finger, a mouse, or the like.

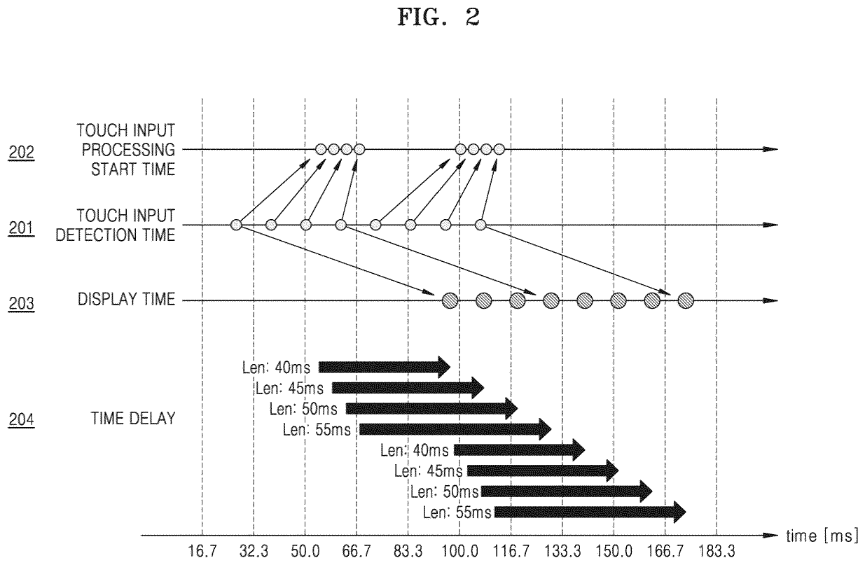

FIG. 2 is a diagram illustrating a time delay that occurs in processing a touch input, according to an embodiment of the disclosure.

Referring to FIG. 2, it is assumed that the screen refresh time is 60 Hz, i.e., 16.67 ms, and the user is drawing a line on the touchscreen of the electronic device 1100 by using the input device 100 (or the finger of the user).

Referring to 201, the touch input may be detected at regular time intervals. The time taken to detect the touch input may be constant.

In an embodiment of the disclosure, the electronic device 1100 may require time until the processing of the touch input begins after the occurrence of the actual touch input. In an embodiment of the disclosure, the time at which the actual touch input is detected may be different from the time at which the processing of the touch input begins. In an embodiment of the disclosure, the time at which the actual touch input is received may be different from the time at which the processing of the touch input begins.

Referring to 202, the time at which the processing of the touch input begins may not be constant. Because the time is delayed until the processing of the touch input begins, the electronic device 1100 may perform the processing of the touch input in batch.

Referring to 203, the electronic device 1100 may output the result of the touch input on the display after a considerable time has passed since the touch input was detected. There may be a difference between the detection of the touch input and the display time of the touch input.

Referring to 204, the electronic device 1100 may require time to display the touch input on the screen. In an embodiment of the disclosure, the time at which the processing of the touch input begins may be different from the time at which the touch input is displayed on the screen.

In an embodiment of the disclosure, the electronic device 1100 may not be able to process the touch input for a significant time due to other background tasks while receiving the touch input on the touchscreen. This may slow down the processing speed for the touch input. In an embodiment of the disclosure, the electronic device 1100 may experience a delay in processing the touch input according to CPU performance and current load.

In an embodiment of the disclosure, because data for the touch input is queued, the CPU may receive a plurality of pieces of data to be processed at once. In an embodiment of the disclosure, the electronic device 1100 may detect data for a large number of touch inputs in time slots between screen refresh times. When the electronic device 1100 determines to process all touch inputs, the load to be processed may be increased and the screen refresh time may be delayed.

In an embodiment of the disclosure, when the electronic device 1100 detects data for the touch input within a time that is insufficient to process data within the screen refresh time, the electronic device 1100 may not display the result of the touch input on the screen. Therefore, data regarding the touch input may be transmitted to a next screen refresh time slot.

When data for a large number of touch inputs are processed in batch, screen refresh may be delayed, and when data for the touch input is detected in a time that is too late to process data, the result of the touch input may not be displayed on the screen within a time even though the data is processed. This latency hinders performance of the electronic device.

Through exemplary embodiments of the disclosure described below, the processing of the touch input may be optimized and adjusted to match the screen refresh time, and thus, the load on the CPU and the GPU may be reduced. Furthermore, it is possible to perform better prediction of the touch input by simultaneously reducing CPU usage and GPU usage, to secure more CPU and GPU power for other processes, and to adapt to touch input time difference patterns. Moreover, it is possible to compensate for a delay that occurs when the screen refresh time changes due to high load on the CPU and the GPU, and to utilize many algorithms within the given time constraints to draw content on the screen.

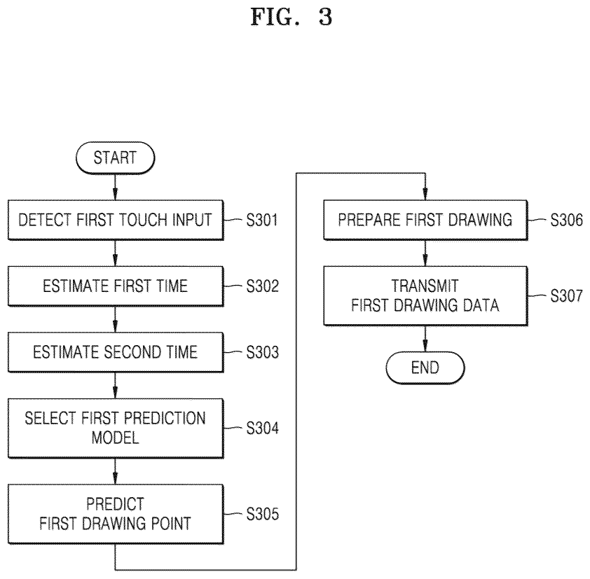

FIG. 3 is a flowchart illustrating a method of processing one touch input, according to an embodiment of the disclosure.

Referring to FIG. 3, when one touch input is detected, the electronic device 1100 may process one touch input and display a drawing on the screen by performing the following operations.

In operation S301, the electronic device 1100 may detect a first touch input. In an embodiment of the disclosure, the first touch input may be detected on the touchscreen of the electronic device 1100. In an embodiment of the disclosure, the first touch input may be detected on the display of the electronic device 1100.

In an embodiment of the disclosure, the electronic device 1100 may detect the first touch input that is input by using the input device 100 (or the finger of the user). In an embodiment of the disclosure, the first touch input may be detected on the touchscreen or the display of the electronic device 1100.

In an embodiment of the disclosure, the input device 100 (or the finger of the user) may interact with the electronic device 1100 by using pressure, electromagnetic induction, or Bluetooth. In an embodiment of the disclosure, the input device 100 (or the finger of the user) may be used to draw dots or lines on the touchscreen or the display of the electronic device 1100.

In an embodiment of the disclosure, the electronic device 1100 may detect the first touch input corresponding to the drawing of the input device 100 (or the finger of the user). In an embodiment of the disclosure, the electronic device 1100 may detect the first touch input based on the drawing of the input device 100 (or the finger of the user).

In an embodiment of the disclosure, the detecting of the first touch input may be a concept that includes both the detecting of the first touch input and the processing of the first touch input. In an embodiment of the disclosure, the detecting of the first touch input may be a concept that includes both the detecting of the first touch input and the preprocessing of the first touch input.

In an embodiment of the disclosure, the electronic device 1100 may process the detected first touch input. In an embodiment of the disclosure, the electronic device 1100 may preprocess the detected first touch input. In an embodiment of the disclosure, the CPU included in the electronic device 1100 may process the detected first touch input.

In an embodiment of the disclosure, the electronic device 1100 may require time to process the detected first touch input. In an embodiment of the disclosure, the CPU included in the electronic device 1100 may require time to process the detected first touch input.

In an embodiment of the disclosure, the electronic device 1100 may detect three-dimensional (3D) coordinates of the first touch input. In an embodiment of the disclosure, the electronic device 1100 may interact with the input device 100 to detect 3D coordinates indicated by a pen tip of the input device 100. In an embodiment of the disclosure, the electronic device 1100 may display two-dimensional (2D) coordinates on the display, based on the 3D coordinates of the first touch input.

In an embodiment of the disclosure, the electronic device 1100 may analyze the time interval between the touch inputs. The electronic device 1100 may analyze time interval patterns between the touch inputs. The electronic device 1100 may identify that the time intervals between the touch inputs are not constant but variable. The electronic device 1100 may analyze time patterns and trends between the touch inputs.

In an embodiment of the disclosure, the electronic device 1100 may estimate a seventh time at which a second touch input is to be detected, based on the analyzed time interval patterns. The electronic device 1100 may estimate whether the second touch input will be detected within a short time or after a long time, based on the time interval patterns between the touch inputs.

In an embodiment of the disclosure, the electronic device 1100 may perform prediction based on the time intervals and patterns between the touch inputs.

In operation S302, the electronic device 1100 may estimate a first time, which is the time from the time point at which the first touch input is detected until the screen is refreshed. For example, when the display has a screen refresh rate of 60 Hz and the time at which the first touch input is detected is 1 ms, the first time, which is the time from the time point at which the first touch input is detected until the screen is refreshed, may be 15.57 ms.

In an embodiment of the disclosure, the electronic device 1100 may calculate the screen refresh time based on the screen refresh rate of the display. In an embodiment of the disclosure, the screen refresh rate may be expressed as a screen scan rate, a screen reproduction rate, a screen reproduction frequency, or a screen playback rate, but the disclosure is not limited thereto. For example, when the screen refresh rate is 60 Hz, the screen refresh time may be 16.67 ms.

In an embodiment of the disclosure, the electronic device 1100 may estimate the first time, which is the time from the time point at which the processing of the first touch input is completed until the screen is refreshed. In an embodiment of the disclosure, the CPU of the electronic device 1100 may estimate the first time, which is the time from the time point at which the processing of the first touch input is completed until the screen is refreshed.

In an embodiment of the disclosure, the electronic device 1100 may estimate the first time, which is the time from the time point at which the detecting and the processing of the first touch input are completed until the screen is refreshed. In an embodiment of the disclosure, the CPU of the electronic device 1100 may estimate the first time, which is the time from the time point at which the detecting and the processing of the first touch input are completed until the screen is refreshed.

In an embodiment of the disclosure, the electronic device 1100 may estimate the first time, which is the time from the time point at which the preprocessing of the first touch input is completed until the screen is refreshed. In an embodiment of the disclosure, the CPU of the electronic device 1100 may estimate the first time, which is the time from the time point at which the preprocessing of the first touch input is completed until the screen is refreshed.

In an embodiment of the disclosure, the electronic device 1100 may estimate the first time, which is the time from the time point at which the detecting and the preprocessing of the first touch input are completed until the screen is refreshed. In an embodiment of the disclosure, the CPU of the electronic device 1100 may estimate the first time, which is the time from the time point at which the detecting and the preprocessing of the first touch input are completed until the screen is refreshed.

In operation S303, the electronic device 1100 may estimate a second time, which is the time required to render a first drawing including a first drawing point corresponding to the first touch input. The electronic device 1100 may estimate the second time, which is the time required to render the first drawing based on the first drawing point corresponding to the first touch input. In other words, the electronic device 1100 may estimate the second time, which is the time required to render the first drawing based on the first drawing point corresponding to the first touch input.

In an embodiment of the disclosure, the second time may refer to the time taken by the CPU to generate and prepare the first drawing and transmit first drawing data to the GPU after the prediction model is performed on the first touch input. In an embodiment of the disclosure, the second time may refer to the time taken to display the first drawing on the screen.

In an embodiment of the disclosure, the first drawing point may refer to a point predicting where the user will draw a line next or how the drawing will progress, based on the drawing made so far, past drawing history, drawing data corresponding to past touch inputs, and the first touch input. Furthermore, in an embodiment of the disclosure, the first drawing including the first drawing point may refer to a drawing that progresses to the predicted first drawing point. For example, when the first drawing point is predicted while the user is drawing a line, a line extending to the predicted first drawing point may correspond to the first drawing. In an embodiment of the disclosure, the rendering may refer to a process of processing data or commands to produce a visual result that is ultimately displayed on the screen.

In an embodiment of the disclosure, the electronic device 1100 may estimate the time interval excluding the second time from the first time. In an embodiment of the disclosure, the time interval may refer to the time interval until the generation of the first drawing begins after the first touch input is detected. In an embodiment of the disclosure, the time interval may refer to the time interval until the preparation or generation of the first drawing begins after the first touch input is detected and processed.

In an embodiment of the disclosure, the time interval excluding the second time from the first time may refer to a practical time for which the prediction may be performed on the first touch input. The electronic device 1100 may select a prediction model capable of performing prediction on the first touch input by using the estimated time interval.

In operation S304, the electronic device 1100 may select at least one first prediction model based on a screen refresh time and a first drawing time. In an embodiment of the disclosure, the electronic device 1100 may select at least one first prediction model that may be executed within a time constraint.

In an embodiment of the disclosure, the electronic device 1100 may select the first prediction model for predicting the first drawing point, based on the first time and the second time. In an embodiment of the disclosure, the electronic device 1100 may select at least one first prediction model that may be executed within a time interval excluding the second time from the first time.

In an embodiment of the disclosure, the first prediction model may be a neural network model trained to predict the first drawing point corresponding to the first touch input by using past touch inputs as training data. The first prediction model may be trained by using drawing data corresponding to past touch inputs as training data. The first prediction model may receive the first touch input as input and predict and output the first drawing point. In an embodiment of the disclosure, the prediction model may be referred to as a prediction algorithm, a prediction neural network model, a prediction AI, or the like, but the disclosure is not limited thereto.

In an embodiment of the disclosure, the first prediction model may learn a user's past drawing pattern or a user's behavior data and predict a position of a next point to be drawn. In an embodiment of the disclosure, the first prediction model may provide a fast and smooth response without delay by predicting the position of the next point to be drawn, based on a current movement pattern.

In operation S305, the electronic device 1100 may predict the first drawing point from the first touch input by using the selected first prediction model. In an embodiment of the disclosure, the drawing data may include a user's past drawing pattern, a past drawing history, a user's behavioral data, and a user's movement pattern.

In an embodiment of the disclosure, the electronic device 1100 may perform prediction on the first touch input by using the at least one first prediction model. In an embodiment of the disclosure, the electronic device 1100 may perform prediction on the first touch input by using the selected at least one first prediction model. In an embodiment of the disclosure, the respective prediction models may have different processing times and accuracies.

In an embodiment of the disclosure, the electronic device 1100 may perform prediction on the first touch input by using two or more first prediction models. In an embodiment of the disclosure, the electronic device 1100 may predict the first drawing point corresponding to the first touch input by using two or more first prediction models.

In an embodiment of the disclosure, predicting the first drawing point corresponding to the first touch input may mean predicting the position of the point to be drawn after the first touch input. In an embodiment of the disclosure, the electronic device 1100 may calculate the position of the point to be drawn after the first touch input by using at least one first prediction model, based on the first touch input and the past touch inputs.

In an embodiment of the disclosure, the first prediction model may output the first drawing point by using the first touch input as input data. The first prediction model may output the first drawing point predicted based on the first touch input.

In an embodiment of the disclosure, the electronic device 1100 may obtain a first prediction result for the first drawing point predicted from the drawing data by using the selected first prediction model. In an embodiment of the disclosure, the first prediction result may include information about the position of the point to be drawn after the first touch input.

In an embodiment of the disclosure, the electronic device 1100 may obtain at least one first prediction result for the position of the point to be drawn after at least the first touch input by using the first prediction model, based on not only the first touch input but also the past touch inputs, the user's past drawing pattern, or the user's behavior data.

In an embodiment of the disclosure, the electronic device 1100 may select the first drawing point based on the first time, the second time, the accuracy, and the error probability. In an embodiment of the disclosure, the electronic device 1100 may select one prediction result from among at least one first prediction result by taking into account time constraints, accuracy criteria, key performance indicator (KPI) criteria, and error probability.

In an embodiment of the disclosure, the electronic device 1100 may select the most appropriate prediction result from among a plurality of prediction results by taking into account time constraints excluding the second time from the first time and the accuracy and error probability according to each prediction model.

In an embodiment of the disclosure, the electronic device 1100 may determine whether to perform prediction on the first touch input, based on the first time, the second time, and the seventh time. The electronic device 1100 may determine whether to perform prediction on the first touch input, based on the time at which the prediction may be performed on the first touch input and the time at which the second touch input is expected to be detected.

In an embodiment of the disclosure, when the second touch input is expected to be detected within a short time, the electronic device 1100 may determine not to perform prediction on the first touch input. When the second touch input is expected to be detected after a significant time, the electronic device 1100 may determine to perform prediction on the first touch input.

In an embodiment of the disclosure, when the electronic device 1100 determines not to perform prediction on the first touch input, the electronic device 1100 may stop performing prediction on the first touch input until the second touch input is detected. The electronic device 1100 may simultaneously perform predictions on the first touch input and the second touch input after the second touch input is detected.

In operation S306, the electronic device 1100 may prepare a first drawing. In an embodiment of the disclosure, the electronic device 1100 may generate the first drawing based on the first drawing point. In an embodiment of the disclosure, the CPU or the GPU included in the electronic device 1100 may generate the first drawing based on the first drawing point.

In an embodiment of the disclosure, the electronic device 1100 may generate a curve or a straight line that connects the first touch input to the first drawing point. The CPU or the GPU of the electronic device 1100 may generate the curve or the straight line that connects the first touch input to the first drawing point.

In operation S307, the electronic device 1100 may transmit the first drawing data to the GPU. In an embodiment of the disclosure, the CPU included in the electronic device 1100 may transmit the first drawing data to the GPU.

In an embodiment of the disclosure, the first drawing data may include data obtained when the CPU or the GPU prepares and generates the first drawing. The first drawing data may include data necessary to display the first drawing on the screen. The first drawing data may include data necessary to render the first drawing.

In an embodiment of the disclosure, the electronic device 1100 may transmit the first drawing data to the GPU. In an embodiment of the disclosure, the CPU included in the electronic device 1100 may transmit the first drawing data to the GPU.

In an embodiment of the disclosure, the electronic device 1100 may display, on the screen, the first drawing generated based on the first drawing point. The electronic device 1100 may display, on the screen, the first drawing generated based on the selected first drawing point.

In an embodiment of the disclosure, the GPU may perform processing so that the first drawing is displayed on the screen, based on the first drawing data. In an embodiment of the disclosure, the GPU may perform processing so that the first drawing is displayed on the screen, based on the first drawing data.

In an embodiment of the disclosure, the electronic device 1100 may render the first drawing data so as to display the first drawing on the screen. In an embodiment of the disclosure, the GPU of the electronic device 1100 may render the first drawing data so as to display the first drawing on the screen.

In an embodiment of the disclosure, the electronic device 1100 may display the first drawing, which is generated based on 3D coordinates of the first touch input, on the display as two-dimensional coordinates.

In an embodiment of the disclosure, the electronic device 1100 may adjust the screen refresh time so that the time at which the first drawing is displayed on the screen is synchronized with the time at which the screen is refreshed.

In an embodiment of the disclosure, the electronic device 1100 may delay the screen refresh time when the time at which the first drawing is displayed on the screen is expected to be later than the screen refresh time. The electronic device 1100 may advance the screen refresh time when the time at which the first drawing is displayed on the screen is expected to be earlier than the screen refresh time.

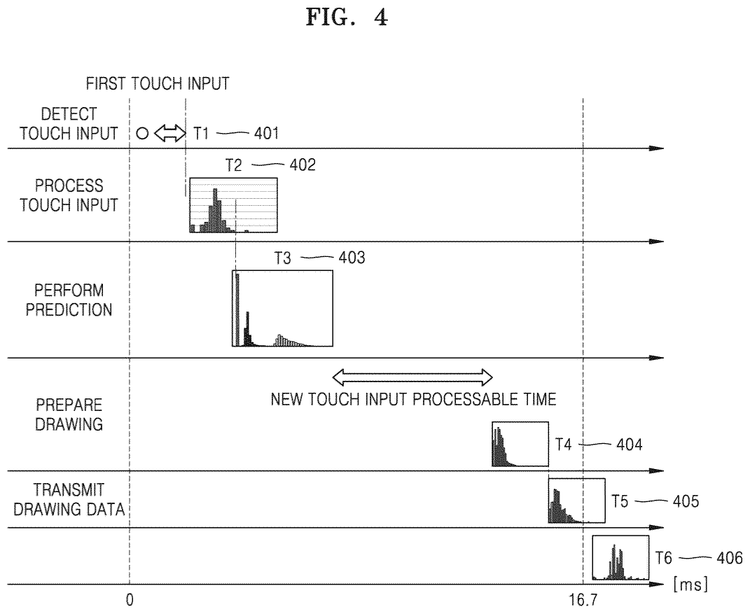

FIG. 4 is a timeline diagram illustrating a process of processing one touch input, according to an embodiment of the disclosure.

FIG. 4 illustrates a time diagram including a histogram of the detecting of the touch input, the processing of the touch input, the performing of the prediction, the preparing of the drawing, the transmitting of the drawing data, and the drawing in the electronic device 1100. The time delay from the touch input to the drawing may be caused by several factors. The main factors causing the time delay are described below.

Referring to 401, the electronic device 1100 may detect a first touch input. The electronic device 1100 may require time to detect the first touch input. The electronic device 1100 may experience a time delay in detecting the first touch input. For example, the time delay caused by the detecting of the first touch input may be represented by T1.

In an embodiment of the disclosure, the time delay T1 caused by the detecting of the first touch input may vary depending on hardware used. For example, the hardware may be various types and forms of electronic devices each including a touchscreen, and may include smart TVs, smart phones, tablet PCs, laptop PCs, eyeglass displays, HMDs, etc. The respective pieces of hardware may have different sensitivities and delays. For example, a highly optimized touchscreen response may occur between about 0.1 ms and about 1 ms.

In an embodiment of the disclosure, the time delay T1 caused by the detecting of the first touch input may vary depending on the input device 100 or input means used on the touchscreen of the electronic device 1100. For example, the input device 100 may include a pointer, a stylus, an electronic pen, etc., and the input means may include a finger, a whole hand, finger gestures, or a mouse.

In an embodiment of the disclosure, the time delay T1 caused by the detecting of the first touch input may vary depending on a window manager that reads a touch event in a driver included in the electronic device 1100 and transmits the touch event to an appropriate application.

In an embodiment of the disclosure, the electronic device 1100 may detect coordinates at which the input device 100 (or the finger of the user) presses the touchscreen. The electronic device 1100 may receive data such as a pressure, slope, or speed of the input device 100 from the input device 100.

Referring to 402, the electronic device 1100 may process the first touch input. The electronic device 1100 may require time to process the first touch input. The electronic device 1100 may experience a time delay in processing the first touch input. For example, the time delay caused by the processing of the first touch input may be represented by T2.

In an embodiment of the disclosure, the CPU of the electronic device 1100 may process the first touch input. In an embodiment of the disclosure, the application included in the electronic device 1100 may process the first touch input. In an embodiment of the disclosure, the time delay T2 caused by the processing of the first touch input may vary depending on the load of the CPU. The load of the CPU may include the number of parallel processes and CPU utilization.

In an embodiment of the disclosure, the processing of the first touch input may be interrupted for a significant time due to CPU power consumed by processes other than the first touch input. The processing of the first touch input may further include a rendering task. The rendering task and the processing task are tasks that run on two separate threads, and synchronization between the two tasks may cause additional delays.

In an embodiment of the disclosure, the electronic device 1100 may transmit the touch event to an operating system or application so that appropriate processing routines may be executed. The electronic device 1100 may determine a response method of a system according to a touch event and may identify whether a touch has occurred or a touch has ended.

In an embodiment of the disclosure, the time difference between touch inputs may not be constant. The time interval between processings of touch inputs may not be constant. In an embodiment of the disclosure, the electronic device 1100 may perform prediction by taking into account non-constant time intervals between touch inputs. The electronic device 1100 may perform prediction by taking into account non-constant time intervals between processings of touch inputs.

In an embodiment of the disclosure, the electronic device 1100 may detect time intervals between touch inputs and trends of the time intervals. In an embodiment of the disclosure, the electronic device 1100 may detect time intervals between processings of touch inputs and trends of the time intervals.

In an embodiment of the disclosure, the electronic device 1100 may select a prediction model and perform prediction, based on the time intervals between touch inputs and the trends of the time intervals. In an embodiment of the disclosure, the electronic device 1100 may select a prediction model and perform prediction, based on the time intervals between processings of touch inputs and the trends of the time intervals.

In an embodiment of the disclosure, when the time interval between touch inputs is short, the electronic device 1100 may detect two or more touch inputs within one screen refresh time. The electronic device 1100 may select a prediction model that may be executed within the time from the time point at which two or more touch inputs are detected until the screen refresh occurs. The electronic device 1100 may simultaneously perform prediction on the two or more touch inputs. The electronic device 1100 may perform prediction by grouping the two or more touch inputs into one.

In an embodiment of the disclosure, when at least one of the two or more touch inputs is not able to be performed within the screen refresh time, the electronic device 1100 may not perform prediction on at least one of the two or more touch inputs. At least one touch input on which the prediction has not been performed may be predicted within a new screen refresh time immediately after the screen refresh occurs.

In an embodiment of the disclosure, when at least one of the two or more touch inputs is not able to be performed within the screen refresh time, the electronic device 1100 may not process at least one of the two or more touch inputs. At least one touch input on which the prediction has not been performed may be processed within a new screen refresh time immediately after the screen refresh occurs.

In an embodiment of the disclosure, when the time interval between processings of touch inputs is short, the electronic device 1100 may select a prediction model that may be executed within a time until the screen refresh occurs with respect to the processed two or more touch inputs. When the processed two or more touch inputs are not able to be predicted within the screen refresh time, the electronic device 1100 may not perform prediction on at least one of the processed two or more touch inputs.

In an embodiment of the disclosure, when the time interval between touch inputs is expected to be short, the electronic device 1100 may not perform the prediction model on one touch input until the next touch input is detected. When the time interval between touch inputs is expected to be short, the electronic device 1100 may not process one touch input until the next touch input is detected.

In an embodiment of the disclosure, when the time interval between processings of touch inputs is expected to be short, the electronic device 1100 may not perform prediction on one touch input until the next touch input is detected.

In an embodiment of the disclosure, when the time interval between touch inputs is long, the electronic device 1100 may perform prediction on one touch input twice or more times. The electronic device 1100 may more accurately predict the drawing point corresponding to the touch input by performing prediction on one touch input twice or more times.

In an embodiment of the disclosure, when the time interval between touch inputs is long, the electronic device 1100 may not perform prediction on at least one touch input. At least one touch input on which the prediction has not been performed may be predicted within the new screen refresh time immediately after the screen refresh occurs.

In an embodiment of the disclosure, when the time interval between touch inputs is long, the electronic device 1100 may not process at least one touch input. At least one touch input that has not been processed may be processed within the new screen refresh time immediately after the screen refresh occurs.

In an embodiment of the disclosure, when the time interval between touch inputs is expected to be long, the electronic device 1100 may perform prediction on one touch input twice or more times. By performing prediction on one touch input twice or more times, the electronic device 1100 may more accurately predict the drawing point corresponding to one touch input.

Referring to 403, the electronic device 1100 may perform prediction on the first touch input by using the first prediction model. The electronic device 1100 may require time to perform prediction on the first touch input. The electronic device 1100 may experience a time delay in performing prediction on the first touch input. For example, the time delay caused by the prediction performed on the first touch input may be represented by T3.

In an embodiment of the disclosure, the electronic device 1100 may estimate a first time, which is the time from the time point at which the first touch input is detected until the screen is refreshed. The electronic device 1100 may estimate a second time, which is the time required to render the first drawing including the first drawing point corresponding to the first touch input. The electronic device 1100 may estimate the second time, which is the time required to render the first drawing based on the first drawing point corresponding to the first touch input.

In an embodiment of the disclosure, the electronic device 1100 may select the first prediction model for predicting the first drawing point, based on the first time and the second time. The electronic device 1100 may predict the first drawing point from the first touch input by using the selected first prediction model. The electronic device 1100 may calculate the first drawing point from the drawing data by using the selected first prediction model.

In an embodiment of the disclosure, the prediction using the first prediction model may be performed by the CPU, GPU, neural processing unit (NPU), or field programmable gate array (FPGA) included in the electronic device 1100, or may be performed by a combination thereof. However, the disclosure is not limited thereto.

In an embodiment of the disclosure, when the number of tasks is significantly small or the processing time is shorter than that of processing on the GPU or is optimal in terms of a system, the prediction using the first prediction model may be performed by the CPU included in the electronic device 1100. When the prediction is performed by the GPU, NPU, or FPGA, the prediction may require time to transmit the touch event from the CPU to the GPU, NPU, or FPGA and to perform prediction and transmit the prediction result back to the CPU.

In an embodiment of the disclosure, the electronic device 1100 may obtain at least one first prediction result by performing prediction using the first prediction model. The electronic device 1100 may perform prediction to obtain at least one first prediction result for the first drawing point corresponding to the first touch input.

In an embodiment of the disclosure, the prediction model may include a prediction algorithm. The prediction model may be executed by the CPU or the GPU. In an embodiment of the disclosure, the electronic device 1100 may predict the drawing point corresponding to the touch input by using the prediction model. The drawing point may refer to the next point to be drawn on the screen in response to the touch input.

Next, four examples of the prediction model are described.

In an embodiment of the disclosure, the prediction model may include a first neural network model. The first neural network model may be executed by the GPU and may output, for example, three predicted X, Y coordinates based on three pieces of input data. Because the first neural network model requires three pieces of input data, the first neural network model may be used when the drawing begins or when the first touch input is detected.

For example, a statistical analysis of the processing time of the first neural network model may have a maximum value of about 2.213 ms, a mean value of about 0.493 ms, a median value of about 0.445 ms, and a standard deviation of about 0.1884 ms. According to the statistics, the probability that the first neural network model will be executed within about 0.822 ms may be expected to be about 95%.

In an embodiment of the disclosure, the prediction model may include a second neural network model. The second neural network model may be executed by the GPU and may provide better prediction at a larger scale, compared to the first neural network model. For example, the second neural network model may output six predicted X, Y coordinates based on eight pieces of input data. The second neural network model may be slower and require more data, compared to the first neural network model.

For example, a statistical analysis of data for the processing time of the second neural network model may have a maximum value of about 10.638 ms, a mean value of about 2.208 ms, a median value of about 2.073 ms, and a standard deviation of about 0.554 ms. According to the statistics, the probability that the second neural network model will be executed within about 3.181 ms may be expected to be about 95%.

In an embodiment of the disclosure, because the first neural network model and the second neural network model are executed by the GPU, the first neural network model and the second neural network model may be required to receive touch input data from the CPU, process the touch input data on the GPU, and then transmit the processed data back to the CPU. The first neural network model and the second neural network model may experience a time delay because data is transmitted and received between the CPU and the GPU.

In an embodiment of the disclosure, the prediction model may include a linear extrapolation model. The linear extrapolation model may be executed by the CPU and may have low computational complexity and output fast results. The linear extrapolation model may be used when the touch input generates a straight line, and accordingly, may output a prediction result in the form of a straight line.

For example, a statistical analysis of data for the processing time of the linear extrapolation model may have a maximum value of about 0.714 ms, a mean value of about 0.0078 ms, a median value of about 0.006 ms, and a standard deviation of about 0.0194 ms. According to the statistics, the probability that the linear extrapolation model will be executed within about 0.0449 ms may be expected to be about 95%.

In an embodiment of the disclosure, the prediction model may include a Kalman filter model. The Kalman filter model may refer to an algorithm that predicts a state that changes over time and modifies the prediction through comparison with observed data. The Kalman filter model may be used to estimate a result from noisy input data or to predict a future state. The Kalman filter model may be used by the CPU and may have poor performance when acceleration or deceleration occurs and line directions change rapidly. The Kalman filter model may require a longer time, compared to the linear extrapolation model.

For example, a statistical analysis of data for the processing time of the Kalman filter model may have a maximum value of about 0.242 ms, a mean value of about 0.005 ms, a median value of about 0.0037 ms, and a standard deviation of about 0.0109 ms. According to the statistics, the probability that the Kalman filter model will be executed within about 0.0255 ms may be expected to be about 95%.

The prediction model is not limited to the four examples described above and may include more neural network models.

In an embodiment of the disclosure, the electronic device 1100 may select a prediction model that is executable within the screen refresh time and performs prediction, by taking into account a processing time probability distribution of a plurality of prediction models. The electronic device 1100 may use various values, such as an execution probability of 90% or 98%, as a threshold value.

Referring to 404, the electronic device 1100 may prepare the first drawing. The electronic device 1100 may require time to prepare the first drawing. The electronic device 1100 may experience a time delay in preparing the first drawing. For example, the time delay caused by the preparing of the first drawing may be represented by T4.

In an embodiment of the disclosure, the electronic device 1100 may prepare content to be displayed on the screen, based on the first drawing point. The electronic device 1100 may prepare the first drawing to be displayed on the screen. The electronic device 1100 may generate the first drawing to be displayed on the screen. The task of preparing or generating the first drawing may be performed by the CPU or the GPU included in the electronic device 1100. However, the disclosure is not limited thereto.

In an embodiment of the disclosure, the first drawing may refer to a line drawn from a first touch input point to a first drawing point. The first drawing may refer to a line drawn from past touch inputs to a first touch input. The first drawing may include both the line drawn from the first touch input point to the first drawing point and the line drawn from the past touch inputs to the first touch input.

In an embodiment of the disclosure, the electronic device 1100 may generate a smoothed line by using various smoothing algorithms. The generating of the smoothed line may refer to connecting the line drawn from the first touch input point to the first drawing point to the line drawn from the past touch inputs to the first touch input point. The generating of the smoothed line may refer to maintaining the curvature of the line at the connection point.

In an embodiment of the disclosure, the task of generating or preparing the first drawing may include a task of creating appropriate vertices to form triangles, a task of transmitting first drawing data to the GPU, and a task of performing rendering and rasterization.

In an embodiment of the disclosure, the rendering may refer to a process of converting various forms of data, such as 3D models, images, videos, and text, into a final form that is visible to humans. In an embodiment of the disclosure, the rasterization may refer to a process of converting a 3D model or vector graphics data in computer graphics into a pixel-wise image for display on a 2D screen.

In an embodiment of the disclosure, the first drawing data may refer to data that enables the GPU to display the first drawing on the screen. The first drawing data may include a command that causes the GPU to display the first drawing on the screen. The first drawing data may include data necessary to render the first drawing.

In operation 405, the electronic device 1100 may transmit the first drawing data to the GPU. In an embodiment of the disclosure, the electronic device 1100 may transmit the first drawing data to the GPU. The electronic device 1100 may require time to transmit the first drawing data to the GPU. The electronic device 1100 may experience a time delay in transmitting the first drawing data to the GPU. For example, the time delay caused by the transmitting of the first drawing data may be represented by T5.

In an embodiment of the disclosure, the task of transmitting of the first drawing data to the GPU may include a task of copying the first drawing data from the CPU to the GPU. The time delay T5 caused by the transmitting of the first drawing data may require more time as more data is copied.

Referring to 406, the electronic device 1100 may display, on the screen, the first drawing generated based on the first drawing point. The electronic device 1100 may display the first drawing on the display. The electronic device 1100 may require time to display the first drawing on the display. The electronic device 1100 may experience a time delay in displaying the first drawing on the display. For example, the time delay caused by the displaying of the first drawing on the screen may be represented by T6.

In an embodiment of the disclosure, the electronic device 1100 may adjust the screen refresh time so that the time at which the first drawing is displayed on the screen is synchronized with the time at which the screen is refreshed. In an embodiment of the disclosure, the synchronization may include both displaying the first drawing on the screen within the screen refresh time and displaying the first drawing on the screen exactly at the time at which the screen is refreshed.

In an embodiment of the disclosure, the time delay T6 caused by the displaying of the first drawing on the screen may include a time required to transmit data necessary for rendering from the CPU to the GPU and a time necessary to update an internal state so that the GPU completes all drawing commands.

The disclosure provides a technical solution for compensating for various types of delays, as described with reference to FIG. 4. The technical solution of the disclosure may be briefly introduced as follows.

Each operation and process described with reference to FIG. 4 has unpredictability when considering touch input detection and processing time, prediction execution time, and drawing time. To determine when and which touch events to process and predict, the following operations may be performed.

In an embodiment of the disclosure, the electronic device 1100 may calculate the times T1 and T2 by taking into account the average delay time and standard deviation of the touch input. When the times T1 and T2 are stable, the electronic device 1100 may replace a time T1+T2 with a single value of time T. The electronic device 1100 may calculate the time available until the operations for the times T4 and T5 are performed. The electronic device 1100 may calculate a given time constraint based on the time until the screen refresh time and the times T4 and T5.

In an embodiment of the disclosure, the electronic device 1100 may determine a prediction model available within a given time constraint. The electronic device 1100 may determine the prediction model by analyzing the time taken to execute the prediction model.

In an embodiment of the disclosure, the electronic device 1100 may perform prediction by using one or more prediction models. When an additional touch input occurs within a given time constraint, the electronic device 1100 may determine whether to recalculate the prediction with a new touch input. The electronic device 1100 may determine whether to perform prediction on the new touch input.

In an embodiment of the disclosure, the electronic device 1100 may analyze the time necessary to perform prediction and determine whether to calculate prediction with the new touch input. The electronic device 1100 may analyze the time necessary to perform prediction and determine whether to perform prediction on the new touch input.

In an embodiment of the disclosure, when the touch input is detected after the times T4 and T5, the electronic device 1100 may not process the touch input and transmit the touch input to the next screen refresh time. When the new touch input is detected after the times T4 and T5, the electronic device 1100 may not perform prediction on the new touch input and transmit the touch input to the next screen refresh time.

In an embodiment of the disclosure, the electronic device 1100 may select one of at least one prediction result obtained by performing the prediction. The selected prediction result may be used to generate and prepare the drawing (T4), and the drawing data may be transmitted to the GPU (T5) and displayed (T6).

In an embodiment of the disclosure, the screen refresh may not occur within the predicted screen refresh time. The electronic device 1100 may transmit drawing data to the GPU after the predicted screen refresh time. When no screen refresh occurs until the drawing data is transmitted to the GPU and processed, the drawing may be displayed on the screen. Due to the power consumption of CPU or the GPU, no screen refresh may occur within the predicted refresh time.

Through the process described above, the delay from the touch input to the drawing may be compensated for. The delay is not a fixed value but varies depending on many factors, and prediction models may have different processing times and different accuracies. The methods of a plurality of prediction models may be mixed so as to reduce errors that may occur on the screen of the electronic device. Furthermore, because CPU and GPU usage is reduced, the load on the CPU and GPU used in the background may be reduced, which ensures the stability of future predictions.

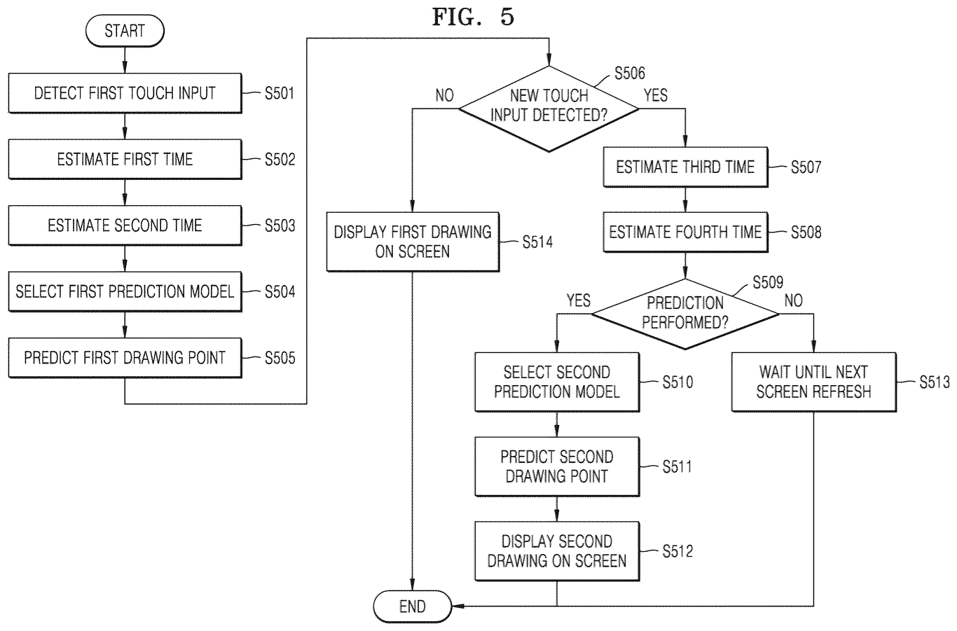

FIG. 5 is a flowchart illustrating a method of processing two or more touch inputs, according to an embodiment of the disclosure.

Referring to FIG. 5, when two or more touch inputs are detected within the same screen refresh time, the electronic device 1100 may perform the following operations to process the touch inputs and display the drawing on the screen. Descriptions redundant with those provided above with reference to FIGS. 3 and 4 are omitted.

In operation S501, the electronic device 1100 may detect a first touch input. The electronic device 1100 may detect the first touch input through a touchscreen. The electronic device 1100 may detect the first touch input through a display. The electronic device 1100 may detect the first touch input that is input through the input device 100 (or the finger of the user).

In operation S502, the electronic device 1100 may estimate a first time, which is the time from the time point at which the first touch input is detected until the screen is refreshed. The electronic device 1100 may estimate the time interval from the detecting and processing of the first touch input to the earliest time at which the screen is refreshed.

In operation S503, the electronic device 1100 may estimate a second time, which is the time required to render a first drawing including a first drawing point corresponding to the first touch input. The second time may include a time necessary to prepare and generate the first drawing and transmit first drawing data to the GPU.

In operation S504, the electronic device 1100 may select a first prediction model for predicting the first drawing point, based on the first time and the second time. The electronic device 1100 may select at least one first prediction model among a plurality of prediction models, which is capable of performing prediction within a time excluding the second time from the first time.

In operation S505, the electronic device 1100 may predict the first drawing point from the first touch input by using the selected first prediction model. The electronic device 1100 may predict the first drawing point based on a history of generating drawings according to past touch inputs. The electronic device 1100 may obtain at least one first drawing point by using the at least one first prediction model having different speeds, times, and accuracies.

In operation S506, the electronic device 1100 may determine whether a new touch input is detected. It is assumed that the new touch input is detected within the same screen refresh time as the first touch input. When the new touch input is detected after the same screen refresh time as the first touch input, this is a touch input at the next screen refresh time. In this case, the electronic device 1100 may perform an operation identical to or similar to the embodiment of FIG. 3.

In an embodiment of the disclosure, the electronic device 1100 may operate a timer. The timer may be a timer that operates until the processing of the new touch input is possible. The timer may be a timer that expires when the time excluding the second time from the first time has elapsed. The timer may be a timer that expires when the last time at which the processing of the new touch input is possible has elapsed. In an embodiment of the disclosure, the time at which the processing of a second touch input is possible may refer to a time excluding the second time from the time remaining until the screen is refreshed. In an embodiment of the disclosure, the time at which the processing of the second touch input is possible may be a time excluding the second time from the first time.

In an embodiment of the disclosure, when the timer expires, the electronic device 1100 may consider that there is no new touch input and may display, on the screen, the first drawing generated based on the first drawing point. When the timer expires, the electronic device 1100 may prepare the first drawing based on the first drawing point corresponding to the first touch input, may transmit first drawing data to the GPU, and may display the first drawing on the screen.

In an embodiment of the disclosure, when the electronic device 1100 determines that the new touch input has been detected, the electronic device 1100 may process the new touch input. The new touch input may include the second touch input. The electronic device 1100 may detect the second touch input. The second touch input may be a touch input that is detected within the same screen refresh time as the first touch input.

In an embodiment of the disclosure, the first drawing point may be replaced with the second touch input. The first drawing point refers to a point predicted to be drawn after the first touch input. Because the second touch input is detected after the first touch input, the first drawing point may not be used to perform drawing.

In operation S507, the electronic device 1100 may estimate a third time, which is the time from the time point at which the second touch input is detected until the screen is refreshed. The electronic device 1100 may estimate the time interval from the detecting and processing of the second touch input to the earliest time at which the screen is refreshed.

In operation S508, the electronic device 1100 may estimate a fourth time, which is the time required to render a second drawing including a second drawing point corresponding to the second touch input. The fourth time may include a time necessary to prepare and generate the second drawing and transmit second drawing data to the GPU.

In an embodiment of the disclosure, the second drawing point may refer to a point predicted to be drawn after the second touch input, based on drawing data corresponding to past touch inputs. In an embodiment of the disclosure, the second drawing may include both a line that connects a line drawn by the past touch inputs including the first touch input to the second touch input, and a line that connects the second touch input to the second drawing point. The line that connects the second touch input to the second drawing point is a line predicted to be drawn and may be expressed in a different color.

In operation S509, the electronic device 1100 may determine whether to perform prediction on the second touch input, based on the third time and the fourth time. The electronic device 1100 may determine whether there is a prediction model capable of performing prediction on the second touch input within a time excluding the fourth time from the third time.

In an embodiment of the disclosure, when the electronic device 1100 determines that there is a prediction model capable of performing prediction on the second touch input within a given time, the electronic device 1100 may determine that it is possible to perform prediction on the second touch input. When the electronic device 1100 determines that there is no prediction model capable of performing prediction on the second touch input within a given time, the electronic device 1100 may determine not to perform prediction on the second touch input.

In operation S510, when the electronic device 1100 determines to perform prediction on the second touch input, the electronic device 1100 may select a second prediction model for predicting the second drawing point, based on the third time and the fourth time. The electronic device 1100 may select at least one second prediction model among a plurality of prediction models, which is capable of performing prediction within a time excluding the fourth time from the third time.

In an embodiment of the disclosure, the second prediction model may be a neural network model trained to predict the second drawing point corresponding to the second touch input by using past touch inputs as training data. The second prediction model may be trained by using drawing data corresponding to past touch inputs as training data. The second prediction model may receive the second touch input as input and predict and output the second drawing point.

In operation S511, the electronic device 1100 may predict the second drawing point from the second touch input by using the selected at least one second prediction model. The electronic device 1100 may predict the second drawing point based on a history of generating drawings according to past touch inputs. The electronic device 1100 may obtain at least one second drawing point by using the at least one second prediction model having different speeds, times, and accuracies.

In operation S512, the electronic device 1100 may display, on the screen, the second drawing generated based on the second drawing point. The electronic device 1100 may render the second drawing by preparing and generating the second drawing based on the second drawing point and transmitting second drawing data to the GPU. The electronic device 1100 may display the rendered second drawing on the screen.

In operation S513, when the electronic device 1100 determines not to perform prediction on the second touch input, the electronic device 1100 may wait until the next screen refresh for the second touch input. When the electronic device 1100 determines that the prediction on the second touch input will not be completed by the screen refresh time even though the prediction is performed on the second touch input, the electronic device 1100 may determine not to perform prediction on the second touch input.

In an embodiment of the disclosure, when the electronic device 1100 determines that the prediction on the second touch input will not be completed by the time excluding the fourth time from the third time even though the prediction is performed on the second touch input, the electronic device 1100 may determine not to perform prediction on the second touch input. When the electronic device 1100 determines that the second drawing will not be displayed on the screen by the screen refresh time even though the prediction is performed on the second touch input, the electronic device 1100 may determine not to perform prediction on the second touch input.

In an embodiment of the disclosure, when the electronic device 1100 determines not to perform prediction on the second touch input, the electronic device 1100 may perform prediction on the second touch input after the screen is refreshed. When the electronic device 1100 determines that the second touch input has been detected at a time that is too late to perform prediction on the second touch input, the electronic device 1100 may determine not to perform prediction on the second touch input.

In an embodiment of the disclosure, when the electronic device 1100 determines that the prediction on the second touch input is impossible within a time excluding the fourth time from the third time, the electronic device 1100 may determine not to perform prediction on the second touch input. When the electronic device 1100 determines that it is impossible to display the second drawing based on the second touch input on the screen until the third time, the electronic device 1100 may determine not to perform prediction on the second touch input.

In an embodiment of the disclosure, when the next screen refresh begins, the electronic device 1100 may perform prediction on the second touch input.

In operation S514, when the electronic device 1100 determines that no new touch input has been detected, the electronic device 1100 may display, on the screen, the first drawing generated based on the first drawing point. The electronic device 1100 may render the first drawing by preparing and generating the first drawing based on the first drawing point and transmitting first drawing data to the GPU. The electronic device 1100 may display the rendered first drawing on the screen.

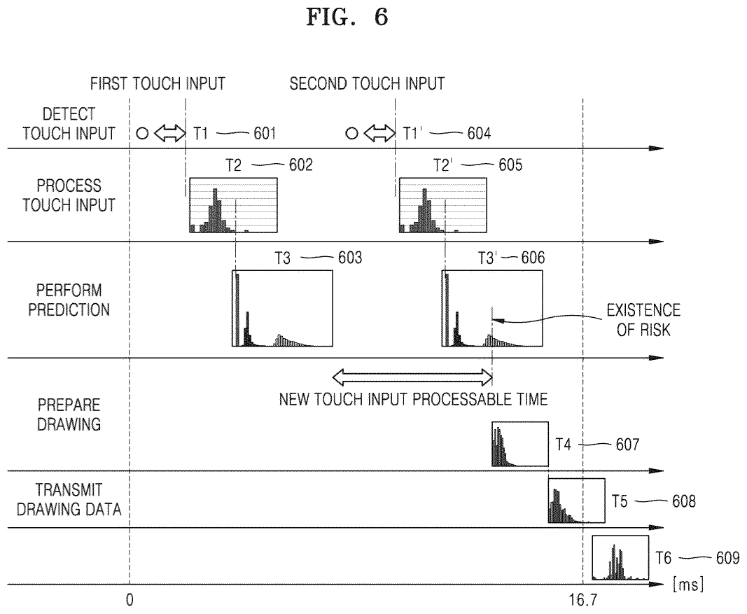

FIG. 6 is a timeline diagram illustrating a process of processing two or more touch inputs, according to an embodiment of the disclosure.

Referring to FIG. 6, when two or more touch inputs are detected within the same screen refresh time, the electronic device 1100 may perform the following operations to process the touch inputs and display the drawing on the screen. Descriptions redundant with those provided above with reference to FIGS. 3, 4, and 5 are omitted.

Referring to 601, the electronic device 1100 may detect a first touch input. The electronic device 1100 may require time to detect the first touch input. The time delay caused by the detecting of the first touch input may be represented by T1.

Referring to 602, the electronic device 1100 may process the first touch input. The electronic device 1100 may require time to process the first touch input. The time delay caused by the processing of the first touch input may be represented by T2.

In an embodiment of the disclosure, the electronic device 1100 may estimate a first time, which is the time from the time point at which the first touch input is detected until the screen is refreshed. The first time may refer to the time interval from time T2 to the time at which the screen refresh occurs.

In an embodiment of the disclosure, the electronic device 1100 may estimate a second time, which is the time required to render a first drawing including a first drawing point corresponding to the first touch input. The second time may refer to a time that is the sum of T4, which is a time delay caused by the preparing of the first drawing, and T5, which is a time delay necessary to transmit first drawing data to the GPU.

In an embodiment of the disclosure, the electronic device 1100 may select the first prediction model for predicting the first drawing point, based on the first time and the second time. The electronic device 1100 may calculate a time interval from time T2 until operations corresponding to time T4 and time T5 are performed. The electronic device 1100 may select a first prediction model that is executable for the first touch input within the time interval described above.

Referring to 603, the electronic device 1100 may predict the first drawing point from the first touch input by using the selected first prediction model. The electronic device 1100 may require time to perform prediction on the first drawing point by using the first prediction model. The time delay caused by the prediction performed on the first drawing point may be represented by T3.

Referring to 604, the electronic device 1100 may detect a second touch input. The electronic device 1100 may detect the second touch input within the screen refresh time. The electronic device 1100 may detect the second touch input within a time at which the processing of a new touch input is possible. The time delay caused by the second touch input may be represented by T1′.

In an embodiment of the disclosure, the time at which the processing of the new touch input is possible may be a time interval from time T3, that is, the time at which the prediction using the first prediction model is performed, to the time excluding T4 and T5 from the time at which the screen refresh occurs.

In an embodiment of the disclosure, when the second touch input is detected after the time at which the processing of the new touch input is possible, the electronic device 1100 may not perform prediction on the second touch input. When the electronic device 1100 determines not to perform prediction on the second touch input, the electronic device 1100 may perform prediction on the second touch input after the screen is refreshed.

Referring to 605, the electronic device 1100 may process the second touch input. The electronic device 1100 may require time to process the second touch input. The time delay caused by the processing of the second touch input may be represented by T2′.

In an embodiment of the disclosure, the electronic device 1100 may estimate a third time, which is the time from the time point at which the second touch input is detected until the screen is refreshed. The third time may refer to the time interval from time T2′ to the time at which the screen refresh occurs.

In an embodiment of the disclosure, the electronic device 1100 may estimate a fourth time, which is the time required to render a second drawing including a second drawing point corresponding to the second touch input. In an embodiment of the disclosure, the electronic device 1100 may estimate the fourth time, which is the time required to render the second drawing based on the second drawing point corresponding to the second touch input. The fourth time may refer to a time that is the sum of T5, which is a time delay caused by the preparing of the second drawing, and T6, which is a time delay necessary to transmit second drawing data to the GPU.

In an embodiment of the disclosure, the electronic device 1100 may determine whether to perform prediction on the second touch input, based on the third time and the fourth time. The electronic device 1100 may determine whether there is a second prediction model capable of performing prediction on the second touch input for a time from time T2′ until operations corresponding to time T4 and time T5 are performed.

In an embodiment of the disclosure, when the electronic device 1100 determines that there is no second prediction model capable of performing prediction on the second touch input, the electronic device 1100 may not perform prediction on the second touch input. When the electronic device 1100 determines that there is the second prediction model capable of performing prediction on the second touch input, the electronic device 1100 may perform the following operations.

In an embodiment of the disclosure, the electronic device 1100 may select the second prediction model for predicting the second drawing point, based on the third time and the fourth time. The electronic device 1100 may calculate a time interval from time T2′ until operations corresponding to time T4 and time T5 are performed. The electronic device 1100 may select the second prediction model that is executable for the first touch input within the time interval described above.

In an embodiment of the disclosure, the electronic device 1100 may select the second prediction model capable of performing prediction faster than the last time at which the operation corresponding to time T4 may be performed. The prediction model that is not executable within a given time constraint may not be selected based on a processing time probability distribution of each prediction model.

In an embodiment of the disclosure, the prediction model that is executable within a given time constraint may produce fast results but may have low accuracy. A prediction model with higher accuracy may produce results too late with non-zero probability. The electronic device 1100 may select an appropriate prediction model by taking into account the constraint conditions. The electronic device 1100 may set a key performance indicator (KPI) set and may select a prediction model based on the KPI set.

Referring to 606, the electronic device 1100 may predict the second drawing point from the second touch input by using the selected second prediction model. The electronic device 1100 may require time to perform prediction on the second drawing point by using the second prediction model. The time delay caused by the prediction performed on the second drawing point may be represented by T3′.

Referring to 607, the electronic device 1100 may prepare the second drawing. The second drawing may include both a line that connects a line drawn by the past touch inputs including the first touch input to the second touch input, and a line that connects the second touch input to the second drawing point. The time delay caused by the preparing of the second drawing may be represented by T4.

In an embodiment of the disclosure, the preparing of the second drawing may refer to generating a smoothed line by using a smoothing algorithm and maintaining the curvature of the line at the connection point. Furthermore, the preparing of the second drawing may include a task of creating appropriate vertices to form triangles, a task of transmitting drawing data to the GPU, and a task of performing rendering and rasterization.

Referring to 608, the electronic device 1100 may transmit the second drawing data to the GPU. The task of transmitting the second drawing data to the GPU may include a task of copying the second drawing data from the CPU to the GPU. The electronic device 1100 may require time to transmit the second drawing data to the GPU. The time delay caused by the transmitting of the second drawing data may be represented by T5.

Referring to 609, the electronic device 1100 may display the second drawing on the screen. The electronic device 1100 may require time to display the second drawing on the display. The time delay caused by the displaying of the second drawing may be represented by T6.

In an embodiment of the disclosure, the electronic device 1100 may adjust the screen refresh time so that the time at which the second drawing is displayed on the screen is synchronized with the screen is refresh time. In an embodiment of the disclosure, the displaying of the second drawing on the screen may include transmitting data necessary for rendering from the CPU to the GPU and updating an internal state so that the CPU completes all drawing commands.

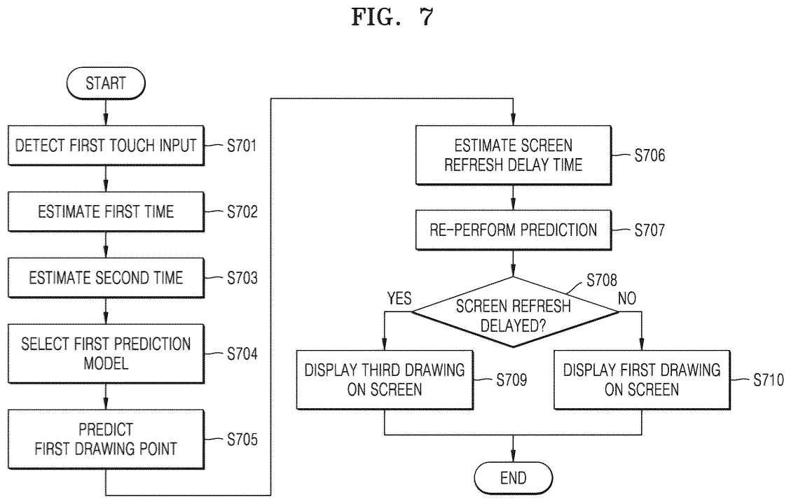

FIG. 7 is a flowchart illustrating a method of processing a touch input based on a screen refresh delay, according to an embodiment of the disclosure.

Referring to FIG. 7, the electronic device 1100 may perform the following operations in case the screen refresh is delayed. Descriptions redundant with those provided above with reference to FIGS. 3, 4, and 5 are omitted.

In operation S701, the electronic device 1100 may detect a first touch input. The electronic device 1100 may detect the first touch input through a touchscreen. The electronic device 1100 may detect the first touch input through a display. The electronic device 1100 may detect the first touch input that is input through the input device 100 (or the finger of the user).

In operation S702, the electronic device 1100 may estimate a first time, which is the time from the time point at which the first touch input is detected until the screen is refreshed. The electronic device 1100 may estimate the time interval from the detecting and processing of the first touch input to the earliest time at which the screen is refreshed.

In operation S703, the electronic device 1100 may estimate a second time, which is the time required to render a first drawing including a first drawing point corresponding to the first touch input. The second time may include a time necessary to prepare and generate the first drawing and transmit first drawing data to the GPU.

In operation S704, the electronic device 1100 may select a first prediction model for predicting the first drawing point, based on the first time and the second time. The electronic device 1100 may select at least one first prediction model among a plurality of prediction models, which is capable of performing prediction within a time excluding the second time from the first time.

In operation S705, the electronic device 1100 may predict the first drawing point from the first touch input by using the selected first prediction model. The electronic device 1100 may predict the first drawing point based on a history of generating drawings according to past touch inputs. The electronic device 1100 may obtain at least one first drawing point by using the at least one first prediction model having different speeds, times, and accuracies.

In operation S706, the electronic device 1100 may estimate a fifth time, which is the time for which the screen refresh is delayed. The electronic device 1100 may assume that the screen refresh will be delayed. For example, when the current screen refresh time is 16.67 ms (i.e., 60 Hz), the screen refresh delay time may include 20 ms (i.e., 50 Hz), 25 ms (i.e., 40 Hz), 33.3 ms (i.e., 30 Hz), etc.

In operation S707, the electronic device 1100 may predict a third drawing point corresponding to the first touch input, based on the first time, the second time, and the fifth time. The electronic device 1100 may predict the third drawing point corresponding to the first touch input by performing new prediction on the first touch input, based on the first time, the second time, and the fifth time. The electronic device 1100 may re-perform prediction on the first touch input, based on the first time, the second time, and the fifth time.

In an embodiment of the disclosure, the electronic device 1100 may select a prediction model that may perform prediction on the first touch input, based on the screen refresh time delayed from the existing screen refresh time and the time necessary to render the third drawing.

In an embodiment of the disclosure, the electronic device 1100 may predict the third drawing point from the drawing data by using the selected prediction model. The selected prediction model may be a prediction model that is executable within the time, based on the delayed screen refresh time and the rendering time.

In operation S708, the electronic device 1100 may determine whether the screen refresh has been delayed. When the refresh does not occur even though the existing screen refresh time has elapsed, the electronic device 1100 may determine that the screen refresh has been delayed.

In operation S709, when the screen refresh is delayed, the electronic device 1100 may display, on the screen, the third drawing generated based on the first drawing point and the third drawing point. The electronic device 1100 may obtain a more accurate prediction result based on the first drawing point and the third drawing point where two or more predictions are performed on the first touch input.

In an embodiment of the disclosure, when the screen refresh is further delayed, the electronic device 1100 may perform additional new prediction on the first touch input. Based on the result of the prediction, the prediction result for the first touch input may have a more accurate value.

In an embodiment of the disclosure, when a new touch input is detected while the screen refresh is delayed, the electronic device 1100 may perform prediction on the new touch input. Detailed operations are implemented through the operations of FIG. 5.

In operation S710, when the screen refresh is not delayed, the electronic device 1100 may display, on the screen, the first drawing generated based on the first drawing point. When the screen refresh is not delayed and the refresh occurs according to the existing screen refresh time, the third drawing point may be in a state of not being predicted yet. The electronic device 1100 may display, on the screen, the first drawing generated based on the first drawing point without the third drawing point.

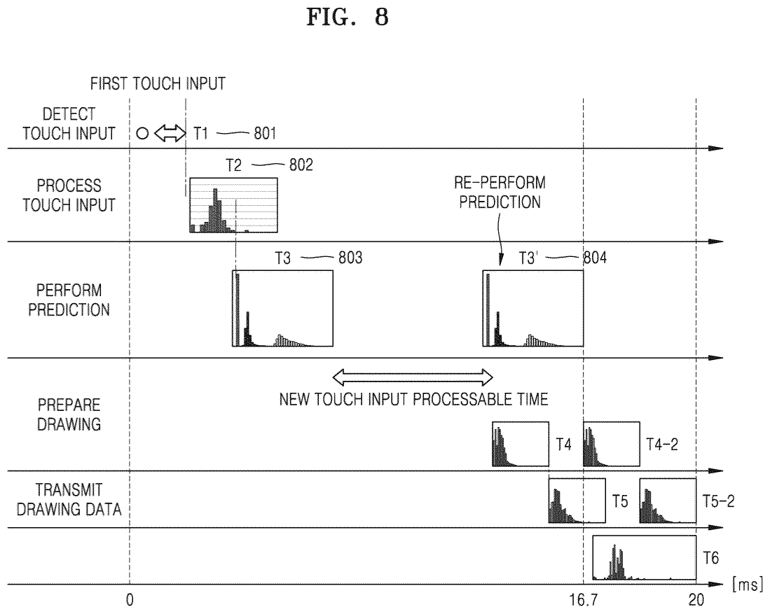

FIG. 8 is a timeline diagram illustrating a process of processing a touch input based on a screen refresh delay, according to an embodiment of the disclosure.

Referring to FIG. 8, the electronic device 1100 may perform the following operations in case the screen refresh is delayed. Descriptions redundant with those provided above with reference to FIGS. 3, 4, 6, and 7 are omitted.

Referring to 801, the electronic device 1100 may detect a first touch input. The electronic device 1100 may require time to detect the first touch input. The time delay caused by the detecting of the first touch input may be represented by T1.

Referring to 802, the electronic device 1100 may process the first touch input. The electronic device 1100 may require time to process the first touch input. The time delay caused by the processing of the first touch input may be represented by T2.

In an embodiment of the disclosure, the electronic device 1100 may estimate a first time, which is the time from the time point at which the first touch input is detected and processed until the screen is refreshed. The first time may refer to the time interval from time T2 to the time at which the screen refresh occurs.

In an embodiment of the disclosure, the electronic device 1100 may estimate a second time, which is the time required to render a first drawing including a first drawing point corresponding to the first touch input. The second time may refer to a time that is the sum of T4, which is a time delay caused by the preparing of the first drawing, and T5, which is a time delay necessary to transmit first drawing data to the GPU.

In an embodiment of the disclosure, the electronic device 1100 may select the first prediction model for predicting the first drawing point, based on the first time and the second time. The electronic device 1100 may calculate a time interval from time T2 until operations corresponding to time T4 and time T5 are performed. The electronic device 1100 may select a first prediction model that is executable for the first touch input within the time interval described above.

In operation S803, the electronic device 1100 may predict the first drawing point from the first touch input by using the selected first prediction model. The electronic device 1100 may require time to perform prediction on the first drawing point by using the first prediction model. The time delay caused by the prediction performed on the first drawing point may be represented by T3.

In an embodiment of the disclosure, the electronic device 1100 may estimate a fifth time, which is the time for which the screen refresh is delayed. The electronic device 1100 may assume that the screen refresh will be delayed. For example, when the current screen refresh time is 16.67 ms (i.e., 60 Hz), the screen refresh delay time may include 20 ms (i.e., 50 Hz).

Referring to 804, the electronic device 1100 may predict a third drawing point corresponding to the first touch input, based on the first time, the second time, and the fifth time. The electronic device 1100 may predict the third drawing point corresponding to the first touch input by performing new prediction on the first touch input, based on the first time, the second time, and the fifth time. The electronic device 1100 may re-perform prediction on the first touch input, based on the first time, the second time, and the fifth time. The time necessary to re-perform prediction on the first touch input may be represented by T3′.

In an embodiment of the disclosure, the electronic device 1100 may select a prediction model that may perform prediction on the first touch input, based on the screen refresh time delayed from the existing screen refresh time and the time required to render the third drawing.

In an embodiment of the disclosure, the time required to render the drawing may include T4-2, which is the time required to prepare the third drawing, and T5-2, which is the time required to transmit third drawing data to the GPU. For example, the electronic device 1100 may select a prediction model that may perform prediction on the first touch input within a time constraint excluding time T4-2 and time T5-2 from 20 ms, which is the delayed screen refresh time.

In an embodiment of the disclosure, the electronic device 1100 may calculate the earliest time at which the prediction has to be performed so as to obtain the result at time T6. The electronic device 1100 may re-perform prediction on the first touch input, based on the calculated time.

In an embodiment of the disclosure, the electronic device 1100 may predict the third drawing point from the first touch input by using the selected prediction model. The selected prediction model may be a prediction model that is executable within the time, based on the delayed screen refresh time and the rendering time.

In an embodiment of the disclosure, the electronic device 1100 may determine whether the screen refresh has been delayed. When the screen refresh does not occur even though the existing screen refresh time has elapsed, the electronic device 1100 may determine that the screen refresh has been delayed.

In an embodiment of the disclosure, when the screen refresh is delayed, the electronic device 1100 may display, on the screen, the third drawing generated based on the first drawing point and the third drawing point. The electronic device 1100 may obtain a more accurate prediction result based on the first drawing point and the third drawing point where two or more predictions are performed on the first touch input.

In an embodiment of the disclosure, when the screen refresh is further delayed, the electronic device 1100 may perform additional new prediction on the first touch input. Based on the result of the prediction, the prediction result for the first touch input may have a more accurate value.

The screen refresh delay may be caused by the screen function and excessive load on the CPU or the GPU in the electronic device 1100. FIGS. 7 and 8 are the embodiment of the disclosure which takes measures to prevent the screen refresh delay. When the screen refresh time is delayed, more accurate data may be obtained, and even though the screen refresh time is not delayed, accurate data may be obtained.

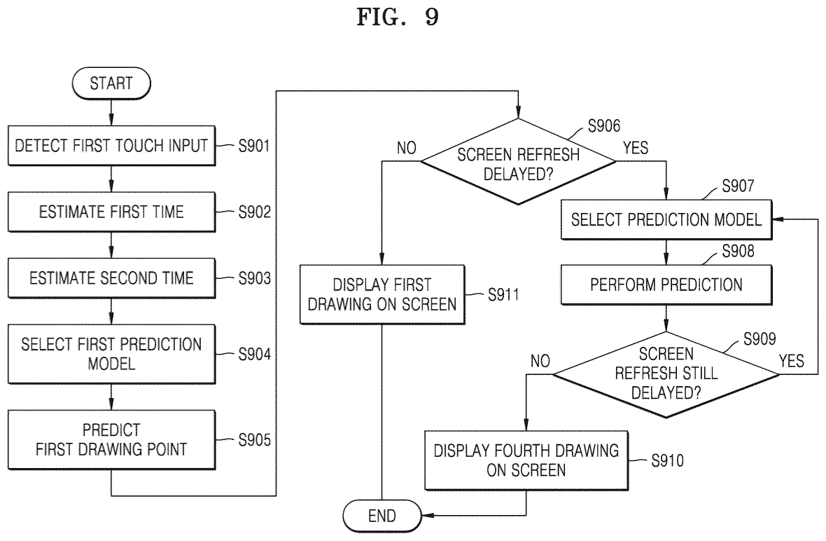

FIG. 9 is a flowchart illustrating a method of processing a touch input when screen refresh is delayed, according to an embodiment of the disclosure.

Referring to FIG. 9, the electronic device 1100 may perform the following operations in case the screen refresh is delayed. Descriptions redundant with those provided above with reference to FIGS. 3 and 4 are omitted.

In operation S901, the electronic device 1100 may detect a first touch input. The electronic device 1100 may detect the first touch input through a touchscreen. The electronic device 1100 may detect the first touch input through a display. The electronic device 1100 may detect the first touch input that is input through the input device 100 (or the finger of the user).

In operation S902, the electronic device 1100 may estimate a first time, which is the time from the time point at which the first touch input is detected until the screen is refreshed. The electronic device 1100 may estimate the time interval from the detecting and processing of the first touch input to the fastest time at which the screen is refreshed.

In operation S903, the electronic device 1100 may estimate a second time, which is the time required to render a first drawing including a first drawing point corresponding to the first touch input. The second time may include a time necessary to prepare and generate the first drawing and transmit first drawing data to the GPU.

In operation S904, the electronic device 1100 may select a first prediction model for predicting the first drawing point, based on the first time and the second time. The electronic device 1100 may select at least one first prediction model among a plurality of prediction models, which is capable of performing prediction within a time excluding the second time from the first time.

In operation S905, the electronic device 1100 may predict the first drawing point from the first touch input by using the selected first prediction model. The electronic device 1100 may predict the first drawing point based on a history of generating drawings according to past touch inputs. The electronic device 1100 may obtain at least one first drawing point by using the at least one first prediction model having different speeds, times, and accuracies.

In operation S906, the electronic device 1100 may identify the screen refresh delay. The electronic device 1100 may determine whether the screen refresh has been delayed. When the screen refresh does not occur even though the existing screen refresh time has elapsed, the electronic device 1100 may determine that the screen refresh has been delayed.

In operation S907, the electronic device 1100 may select a prediction model for predicting a fourth drawing point corresponding to the first touch input, based on the second time and the sixth time that is the delayed screen refresh time. The electronic device 1100 may select a prediction model that may perform prediction on the first touch input, based on the delayed screen refresh time and the time required to render the fourth drawing.

In an embodiment of the disclosure, the electronic device 1100 may predict the fourth drawing point from the first touch input by using the selected prediction model. The selected prediction model may be a prediction model that is executable within the time, based on the delayed screen refresh time and the rendering time.

In operation S908, the electronic device 1100 may predict the fourth drawing point corresponding to the first touch input, based on the second time and the sixth time that is the delayed screen refresh time. The electronic device 1100 may predict the fourth drawing point corresponding to the first touch input by performing new prediction on the first touch input, based on the second time and the sixth time that is the delayed screen refresh time. The electronic device 1100 may re-perform prediction on the first touch input, based on the sixth time and the second time.

In operation S909, the electronic device 1100 may determine whether the screen refresh has still been delayed. For example, this may include a case where the screen refresh time is delayed from 16.67 ms (i.e., 60 Hz) to 20 ms (i.e., 50 Hz), but the screen refresh still did not occur even after 20 ms had elapsed.

In an embodiment of the disclosure, when the screen refresh is still delayed, the electronic device 1100 may re-perform prediction model reselection and prediction on the first touch input. Operations S907 and S908 may be re-performed. The electronic device 1100 may re-perform prediction on the first touch input whenever the screen refresh is delayed. As more predictions are performed, the electronic device 1100 may obtain more accurate prediction results.

In an embodiment of the disclosure, when a new touch input is detected while the screen refresh is delayed, the electronic device 1100 may perform prediction on the new touch input. Detailed operations are implemented through the operations of FIG. 5.

In operation S910, when the screen refresh is no longer delayed, the electronic device 1100 may display, on the screen, the fourth drawing generated based on the first drawing point and the third drawing point. The electronic device 1100 may obtain a more accurate prediction result based on the first drawing point and the fourth drawing point where two or more predictions are performed on the first touch input.

In operation S911, when the screen refresh is not delayed in the first place, the electronic device 1100 may display, on the screen, the first drawing generated based on the first drawing point.

The screen refresh delay may be caused by the screen function and excessive load on the CPU or the GPU in the electronic device 1100. FIG. 9 illustrates the operations that are performed when the screen refresh delay occurs. When the screen refresh time is delayed, the electronic device 1100 may determine the new prediction calculation and select the prediction model based on the available CPU/GPU usage and the prediction time for screen refresh.

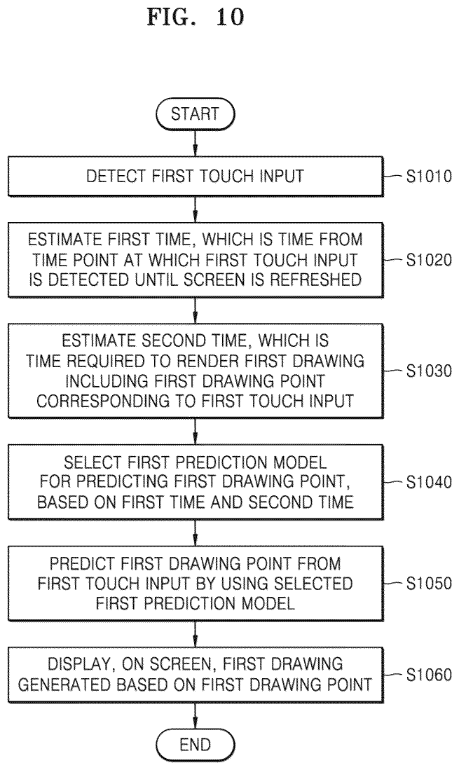

FIG. 10 is a flowchart illustrating an operation of predicting a drawing point, according to an embodiment of the disclosure.

Operations in which the electronic device 1100 predicts the drawing point are briefly described with reference to FIG. 10. Because detailed descriptions of the respective operations have been described with reference to the previous drawings, redundant descriptions thereof are omitted.

In operation S1010, the electronic device 1100 may detect a first touch input. In an embodiment of the disclosure, the electronic device 1100 may detect a second touch input. In an embodiment of the disclosure, the electronic device 1100 may analyze a pattern of the time interval between the touch inputs.

In operation S1020, the electronic device 1100 may estimate a first time, which is the time from the time point at which the first touch input is detected until the screen is refreshed. In an embodiment of the disclosure, the electronic device 1100 may estimate a third time, which is the time from the time point at which the second touch input is detected until the screen is refreshed.

In an embodiment of the disclosure, the electronic device 1100 may estimate a fifth time, which is the time for which the screen refresh is delayed. In an embodiment of the disclosure, the electronic device 1100 may identify the screen refresh delay.

In an embodiment of the disclosure, the electronic device 1100 may estimate a seventh time at which a second touch input is to be detected, based on the analyzed time interval pattern.

In operation S1030, the electronic device 1100 may estimate a second time, which is the time required to render a first drawing including a first drawing point corresponding to the first touch input. In an embodiment of the disclosure, the electronic device 1100 may estimate a fourth time, which is the time required to render a second drawing including a second drawing point corresponding to the second touch input.

In an embodiment of the disclosure, the electronic device 1100 may determine whether to perform prediction on the second touch input, based on the third time and the fourth time. In an embodiment of the disclosure, in case that the electronic device 1100 determines not to perform prediction on the second touch input, the electronic device 1100 may perform prediction on the second touch input after the screen is refreshed.

In an embodiment of the disclosure, the electronic device 1100 may determine whether to perform prediction on the first touch input, based on the first time, the second time, and the seventh time. In an embodiment of the disclosure, in case that the electronic device 1100 determines not to perform prediction on the first touch input, the electronic device 1100 may stop performing prediction on the first touch input until the second touch input is detected.

In operation S1040, the electronic device 1100 may select a first prediction model for predicting the first drawing point, based on the first time and the second time. In an embodiment of the disclosure, in case that the electronic device 1100 determines to perform prediction on the second touch input, the electronic device 1100 may select a second prediction model for predicting the second drawing point, based on the third time and the fourth time.

In an embodiment of the disclosure, the first prediction model may be a neural network model trained to predict the first drawing point corresponding to the first touch input by using past touch inputs as training data. In an embodiment of the disclosure, the second prediction model may be a neural network model trained to predict the second drawing point corresponding to the second touch input by using past touch inputs as training data.

In operation S1050, the electronic device 1100 may predict the first drawing point from the first touch input by using the selected first prediction model. In an embodiment of the disclosure, the electronic device 1100 may predict the second drawing point from the second touch input by using the selected second prediction model.

In an embodiment of the disclosure, the electronic device 1100 may predict a third drawing point corresponding to the first touch input, based on the first time, the second time, and the fifth time. The electronic device 1100 may predict the third drawing point corresponding to the first touch input by performing new prediction on the first touch input, based on the first time, the second time, and the fifth time. In an embodiment of the disclosure, the electronic device 1100 may predict a fourth drawing point corresponding to the first touch input by performing new prediction on the first touch input, based on the second time and the sixth time that is the delayed screen refresh time.

In operation S1060, the electronic device 1100 may display, on the screen, the first drawing generated based on the first drawing point. In an embodiment of the disclosure, the electronic device 1100 may display, on the screen, the second drawing generated based on the second drawing point.

In an embodiment of the disclosure, the electronic device 1100 may display, on the screen, the third drawing generated based on the first drawing point and the third drawing point. In an embodiment of the disclosure, the electronic device 1100 may display, on the screen, the fourth drawing generated based on the first drawing point and the fourth drawing point.

In an embodiment of the disclosure, the electronic device 1100 may select the first drawing point based on the first time, the second time, the accuracy, and the error probability. In an embodiment of the disclosure, the electronic device 1100 may display, on the screen, the first drawing generated based on the selected first drawing point.

In an embodiment of the disclosure, the electronic device 1100 may adjust the screen refresh time so that the time at which the first drawing is displayed on the screen is synchronized with the time at which the screen is refreshed.

The operations described above may be implemented on any device with a touchscreen and drawing engine software (the case of drawing lines or moving a pointer by using a stylus, a finger, or a mouse). There are no limitations on hardware or software.

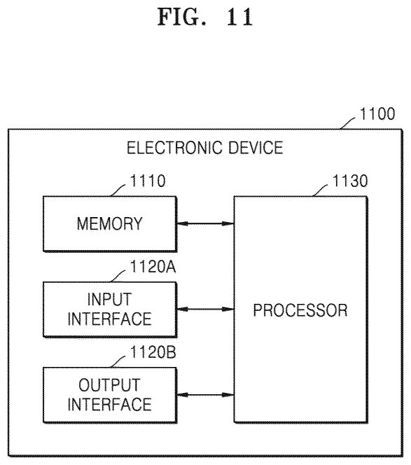

FIG. 11 is a block diagram illustrating a configuration of an electronic device 1100, according to an embodiment of the disclosure.

In an embodiment of the disclosure, the electronic device 1100 may include memory 1110, an input interface 1120A, an output interface 1120B, and a processor 1130.

The memory 1110 may store instructions, a data structure, and program code, which are readable by the processor 1130. Operations performed by the processor 1130 may be implemented by executing instructions or codes of programs stored in the memory 1110.

The memory 1110 may include flash memory-type memory, hard disk-type memory, multimedia card micro-type memory, or card-type memory (e.g., secure digital (SD) or extreme digital (XD) memory), may include a non-volatile memory including at least one of read-only memory (ROM), electrically erasable programmable read-only memory (EEPROM), programmable read-only memory (PROM), magnetic memory, magnetic disc, or optical disc, and may include a volatile memory, such as random access memory (RAM) or static random access memory (SRAM).

The input interface 1120A may include a touchscreen, a keyboard, a microphone, sensor, or the like, that receives commands or information from a user, and the output interface 1120B may include a display panel, a projector, a speaker, or the like that displays the result of performing operations according to a user's command or the state of the electronic device 1100. According to an embodiment of the disclosure, the electronic device 1100 may receive input data from the user through the input interface 1120A, and when a task is completed, may output the result of performing the task through the output interface 1120B.

The processor 1130 may control the overall operations of the electronic device 1100. For example, the processor 1130 may control the overall operations of causing the electronic device 1100 to generate the drawing point by executing one or more instructions of a program stored in the memory 1110. One or more processors 1130 may be provided.

The processor 1130 may include, for example, at least one of CPUs, microprocessors, GPUs, application specific integrated circuits (ASICs), digital signal processors (DSPs), digital signal processing devices (DSPDs), programmable logic devices (PLDs), field programmable gate arrays (FPGAs), application processors (APs), neural processing units, or dedicated AI processors designed with a hardware structure specialized for processing an AI model, but the disclosure is not limited thereto.

Although not illustrated in FIG. 11, the electronic device 1100 may further include additional components to perform the operations described in the aforementioned embodiments of the disclosure. For example, the electronic device 1100 may further include a display, a camera, a microphone, a speaker, a touchscreen, a communication interface, etc.

When the method according to an embodiment of the disclosure includes a plurality of operations, the operations may be performed by one processor or a plurality of processors. For example, when a first operation, a second operation, and a third operation are performed by the method according to an embodiment of the disclosure, the first operation, the second operation, and the third operation may all be performed by a first processor. Alternatively, the first operation and the second operation may be performed by the first processor (e.g., a general-purpose processor) and the third operation may be performed by a second processor (e.g., a dedicated AI processor). The dedicated AI processor, which is an example of the second processor, may perform operations for training and inference of an AI model. However, an embodiment of the disclosure is not limited thereto.

The at least one processor according to the disclosure may be implemented as a single-core processor or may be implemented as a multi-core processor.

When the method according to an embodiment of the disclosure includes a plurality of operations, the operations may be performed by one core or may be performed by a plurality of cores included in the at least one processor.

The disclosure relates to a method, an electronic device, and a system for predicting a drawing point. The technical objectives to be achieved by the disclosure are not limited to the technical objectives described above, and other technical objectives that are not described herein will be clearly understood from the following description by those of ordinary skill in the art.

According to an aspect of the disclosure, a method, performed by an electronic device, of predicting a drawing point may be provided.

The method may include detecting a second touch input.

The method may include estimating a third time, which is a time from a time point at which the second touch input is detected until the screen is refreshed.

The method may include estimating a fourth time, which is a time required to render a second drawing including a second drawing point corresponding to the second touch input.

The method may include determining whether to perform prediction on the second touch input, based on the third time and the fourth time.

The method may include, in case that it is determined to perform prediction on the second touch input, selecting a second prediction model for predicting the second drawing point, based on the third time and the fourth time.

The method may include predicting the second drawing point from the second touch input by using the selected second prediction model.

The method may include displaying, on the screen, the second drawing generated based on the second drawing point.

The method may include, in case that it is determined not to perform prediction on the second touch input, performing prediction on the second touch input after the screen is refreshed.

The first prediction model may include a neural network model trained to predict the first drawing point corresponding to the first touch input by using past touch inputs as training data.

The second prediction model may include a neural network model trained to predict the second drawing point corresponding to the second touch input by using the past touch inputs as training data.

The method may include estimating a fifth time, which is a time for which a screen refresh is delayed.

The method may include predicting a third drawing point corresponding to the first touch input, based on the first time, the second time and the fifth time.

The method may include displaying, on the screen, the third drawing generated based on the first drawing point and the third drawing point.

The method may include identifying a screen refresh delay.

The method may include predicting a fourth drawing point corresponding to the first touch input, based on the second time and a sixth time that is a time for which a screen refresh is delayed.

The method may include displaying, on the screen, a fourth drawing generated based on the first drawing point and the fourth drawing point.

The method may include selecting the first drawing point based on the first time, the second time, accuracy, and an error probability.

The method may include displaying, on the screen, the first drawing generated based on the selected first drawing point.

The method may include adjusting a screen refresh time so that a time at which the first drawing is displayed on the screen is synchronized with a time at which the screen is refreshed.

The method may include analyzing a pattern of a time interval between touch inputs. The method may include estimating a seventh time at which the second touch input is to be detected, based on the analyzed pattern of the time interval.

The method may include determining whether to perform prediction on the first touch input, based on the first time, the second time, and the seventh time.

The method may include, in case that it is determined not to perform prediction on the first touch input, stopping performing prediction on the first touch input until the second touch input is detected.

According to an aspect of the disclosure, an electronic device for predicting a drawing point may be provided.

The electronic device may include an input interface, an output interface, memory storing at least one instruction, and at least one processor configured to execute the at least one instruction stored in the memory.

The at least one processor may be configured to execute the at least one instruction to detect a second touch input.

The at least one processor may be configured to execute the at least one instruction to estimate a third time, which is a time from a time point at which the second touch input is detected until the screen is refreshed.

The at least one processor may be configured to execute the at least one instruction to estimate a fourth time, which is a time required to render a second drawing including a second drawing point corresponding to the second touch input.

The at least one processor may be configured to execute the at least one instruction to determine whether to perform prediction on the second touch input, based on the third time and the fourth time.

The at least one processor may be configured to execute the at least one instruction to, in case that it is determined to perform prediction on the second touch input, select a second prediction model for predicting the second drawing point, based on the third time and the fourth time.

The at least one processor may be configured to execute the at least one instruction to predict the second drawing point from the second touch input by using the selected second prediction model.

The at least one processor may be configured to execute the at least one instruction to display, on the screen, the second drawing generated based on the second drawing point.

The at least one processor may be further configured to execute the at least one instruction to, in case that it is determined not to perform prediction on the second touch input, perform prediction on the second touch input after the screen is refreshed.

The at least one processor may be further configured to execute the at least one instruction to estimate a fifth time, which is a time for which a screen refresh is delayed.

The at least one processor may be further configured to execute the at least one instruction to predict a third drawing point corresponding to the first touch input, based on the first time, the second time and the fifth time.

The at least one processor may be further configured to execute the at least one instruction to display, on the screen, the third drawing generated based on the first drawing point and the third drawing point.

The at least one processor may be further configured to execute the at least one instruction to identify a screen refresh delay.

The at least one processor may be further configured to execute the at least one instruction to predict a fourth drawing point corresponding to the first touch input, based on the second time and a sixth time that is a time for which a screen refresh is delayed.

The at least one processor may be further configured to execute the at least one instruction to display, on the screen, a fourth drawing generated based on the first drawing point and the third drawing point.

The at least one processor may be further configured to execute the at least one instruction to select the first drawing point based on the first time, the second time, accuracy, and an error probability.

The at least one processor may be further configured to execute the at least one instruction to display, on the screen, the first drawing generated based on the selected first drawing point.

The at least one processor may be further configured to execute the at least one instruction to adjust a screen refresh time so that a time at which the first drawing is displayed on the screen is synchronized with a time at which the screen is refreshed.

The at least one processor may be further configured to execute the at least one instruction to analyze a pattern of a time interval between touch inputs.

The at least one processor may be further configured to execute the at least one instruction to estimate a seventh time at which the second touch input is to be detected, based on the analyzed pattern of the time interval.

The at least one processor may be further configured to execute the at least one instruction to determine whether to perform prediction on the first touch input, based on the first time, the second time, and the seventh time.

The embodiment of the disclosure may be implemented in the form of a computer-readable recording medium including computer-executable instructions, such as program modules that are executable by a computer. A computer-readable recording medium may be any available media that are accessible by a computer and may include any volatile and non-volatile media and any removable and non-removable media. In addition, the computer-readable recording medium may include a computer storage medium and a communication medium. The computer-readable storage medium may include any volatile, non-volatile, removable, and non-removable media that are implemented in any method or technology for storage of information, such as computer-readable instructions, data structures, program modules, or other data. The communication medium may typically include other data of modulated data signals, such as computer-readable instructions, data structures, or program modules.

A machine-readable storage medium may be provided in the form of a non-transitory storage medium. The “non-transitory storage medium” is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

A method according to an embodiment of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

The foregoing description of the disclosure is for illustrative purposes only, and those of ordinary skill in the art to which the disclosure pertains will understand that modifications into other specific forms may be made thereto without changing the technical spirit or essential features of the disclosure. Therefore, it should be understood that the embodiments described above are illustrative in all respects and are not restrictive. For example, components described as a single entity may be implemented in a distributed manner. Similarly, components described as distributed may be implemented in a combined manner.

The scope of the disclosure is indicated by the claims described below, and all changes or modifications derived from the meaning and scope of the claims and the equivalent concepts thereof should be interpreted as falling within the scope of the disclosure.

What is claimed is:

1. A method, performed by an electronic device, of predicting a drawing point, the method comprising:
detecting a first touch input;
estimating, as a first time, a time from the detection of the first touch input until a screen is refreshed;
estimating, as a second time, a time to render a first drawing including a first drawing point corresponding to the first touch input;
selecting a first prediction model for predicting the first drawing point, based on the first time and the second time;
predicting the first drawing point from the first touch input by using the selected first prediction model; and
displaying, on the screen, the first drawing including the first drawing point.

2. The method of claim 1, further comprising:
detecting a second touch input;
estimating, as a third time, a time from the detection of the second touch input until the screen is refreshed;
estimating, as a fourth time, a time to render a second drawing including a second drawing point corresponding to the second touch input;
determining whether to perform a prediction on the second touch input, based on the third time and the fourth time;
based on determining to perform the prediction on the second touch input, selecting a second prediction model for predicting the second drawing point, based on the third time and the fourth time;
predicting the second drawing point from the second touch input by using the selected second prediction model; and
displaying, on the screen, the second drawing including the second drawing point.

3. The method of claim 2, further comprising:
based on determining not to perform the prediction on the second touch input, performing the prediction on the second touch input after the screen is refreshed.

4. The method of claim 2,
wherein the first prediction model includes a neural network model trained to predict the first drawing point from the first touch input by using past touch inputs as training data, and
wherein the second prediction model includes a neural network model trained to predict the second drawing point from the second touch input by using the past touch inputs as training data.

5. The method of claim 1, further comprising:
estimating, as a fifth time, a time for which a screen refresh is delayed;
predicting a third drawing point from the first touch input, based on the first time, the second time and the fifth time; and
displaying, on the screen, a third drawing including the first drawing point and the third drawing point.

6. The method of claim 1, further comprising:
identifying, as a sixth time, a time for which a screen refresh is delayed;
predicting a fourth drawing point from the first touch input, based on the second time and the sixth time; and
displaying, on the screen, a fourth drawing including the first drawing point and the fourth drawing point.

7. The method of claim 1, wherein the displaying, on the screen, the first drawing including the first drawing point comprises:
selecting, among at least one prediction result, the first drawing point based on the first time, the second time, an accuracy, and an error probability; and
displaying, on the screen, the first drawing including the selected first drawing point.

8. The method of claim 1, wherein the displaying, on the screen, the first drawing including the first drawing point comprises:
adjusting a screen refresh time to synchronize a time at which the first drawing is displayed on the screen with a time at which the screen is refreshed.

9. The method of claim 2, further comprising:
analyzing a pattern of a time interval between touch inputs;
estimating a seventh time at which the second touch input is to be detected, based on the analyzed pattern of the time interval; and
determining whether to perform a prediction on the first touch input, based on the first time, the second time, and the seventh time.

10. The method of claim 9, further comprising:
based on determining not to perform the prediction on the first touch input, stop performing the prediction on the first touch input until the second touch input is detected.

11. An electronic device for predicting a drawing point, the electronic device comprising:
an input interface;
an output interface;
memory storing at least one instruction; and
at least one processor configured to execute the at least one instruction stored in the memory to cause the electronic device to:
detect a first touch input,
estimate, as a first time, a time from the detection of the first touch input until a screen is refreshed,
estimate, as a second time, a time to render a first drawing including a first drawing point corresponding to the first touch input,
select a first prediction model for predicting the first drawing point, based on the first time and the second time,
predict the first drawing point from the first touch input by using the selected first prediction model, and
display, on the screen, the first drawing including the first drawing point.

12. The electronic device of claim 11, wherein the at least one processor is further configured to execute the at least one instruction to cause the electronic device to:
detect a second touch input,
estimate, as a third time, a time from the detection of the second touch input until the screen is refreshed,
estimate, as a fourth time, a time to render a second drawing including a second drawing point corresponding to the second touch input,
determine whether to perform a prediction on the second touch input, based on the third time and the fourth time,
based on determining to perform the prediction on the second touch input, select a second prediction model for predicting the second drawing point, based on the third time and the fourth time,
predict the second drawing point from the second touch input by using the selected second prediction model, and
display, on the screen, the second drawing including the second drawing point.

13. The electronic device of claim 12, wherein the at least one processor is further configured to execute the at least one instruction to cause the electronic device to:
based on determining not to perform the prediction on the second touch input, perform the prediction on the second touch input after the screen is refreshed.

14. The electronic device of claim 12,
wherein the first prediction model includes a neural network model trained to predict the first drawing point from the first touch input by using past touch inputs as training data, and
wherein the second prediction model includes a neural network model trained to predict the second drawing point from the second touch input by using the past touch inputs as training data.

15. The electronic device of claim 11, wherein the at least one processor is further configured to execute the at least one instruction to cause the electronic device to:
estimate, as a fifth time, a time for which a screen refresh is delayed,
predict a third drawing point from the first touch input, based on the first time, the second time and the fifth time, and
display, on the screen, a third drawing including the first drawing point and the third drawing point.

16. The electronic device of claim 11, wherein the at least one processor is further configured to execute the at least one instruction to cause the electronic device to:
identify, as a sixth time, a time for which a screen refresh is delayed,
predict a fourth drawing point from the first touch input, based on the second time and the sixth time, and
display, on the screen, a fourth drawing including the first drawing point and the fourth drawing point.

17. The electronic device of claim 11, wherein the at least one processor is further configured to execute the at least one instruction to cause the electronic device to:
select the first drawing point, among at least one prediction result, based on the first time, the second time, an accuracy, and an error probability, and
display, on the screen, the first drawing including the selected first drawing point.

18. The electronic device of claim 11, wherein the at least one processor is further configured to execute the at least one instruction to cause the electronic device to:
adjust a screen refresh time to synchronize a time at which the first drawing is displayed on the screen with a time at which the screen is refreshed.

19. The electronic device of claim 12, wherein the at least one processor is further configured to execute the at least one instruction to cause the electronic device to:
analyze a pattern of a time interval between touch inputs,
estimate a seventh time at which the second touch input is to be detected, based on the analyzed pattern of the time interval, and
determine whether to perform a prediction on the first touch input, based on the first time, the second time, and the seventh time.

20. A computer-readable recording medium having recorded thereon a program for causing a computer to perform the method of claim 1.
